(19) United States
(12) Patent Application Publication
(10) Pub. No.: US 2022/0298301 A1
(43) Pub. Date: Sep. 22, 2022

(54) FLUORINATED ETHER COMPOUND, COMPOSITION, AND ARTICLE PROVIDED WITH WATER AND OIL REPELLENT LAYER

(71) Applicant: AGC Inc., Tokyo (JP)

(72) Inventors: Masayuki HARAGUCHI, Tokyo (JP); Makoto UNO, Tokyo (JP); Yusuke TOMIYORI, Tokyo (JP); Toyokazu ENTA, Tokyo (JP)

(73) Assignee: AGC Inc., Tokyo (JP)

(21) Appl. No.: 17/804,356

(22) Filed: May 27, 2022

Related U.S. Application Data
(63) Continuation of application No. PCT/JP2020/045524, filed on Dec. 7, 2020.

(30) Foreign Application Priority Data
Dec. 13, 2019 (JP) 2019-225334
Sep. 1, 2020 (JP) 2020-146621

(51) Int. Cl. C08G 65/00; B05D 5/08

(52) U.S. Cl. CPC C08G 65/007; B05D 5/083; B05D 2202/45; B05D 2506/10

(57) ABSTRACT

To provide a fluorinated ether compound capable of forming a water and oil repellent layer with excellent abrasion resistance on a metal surface of a substrate, a composition, and an article provided with a water and oil repellent layer.

The fluorinated ether compound of the present invention is represented by [R^{f}—(OX)ₘ—O—]ⱼ₁Y¹—Z¹[-L¹-S—R¹¹]_{g11}[R¹²]_{g12}. R^{f} is a perfluoroalkyl group, X is a fluoroalkylene group having at least one fluorine atom, m is an integer of at least 2, Y¹ is a single bond or a (j1+1) valent linking group, and Z¹ is a (g11+g12+1) valent linking group, L¹ is a single bond or a divalent linking group, R¹¹ is a hydrogen atom or a monovalent substituent, R¹² is a hydrogen atom or a monovalent substituent, j1 is an integer of at least 1, g11 is an integer of at least 2, and g12 is an integer of at least 0.

### TECHNICAL FIELD

The present invention relates to a fluorinated ether compound, a composition, and an article provided with a water and oil repellent layer.

### BACKGROUND ART

In order to impart water and oil repellency, fingerprint smudge cleanability, lubricity (smoothness when touched with a finger), etc. to the surface of a substrate, it is known to form a water and oil repellent layer consisting of a condensation product of a fluorinated compound on the surface of the substrate by surface treatment using a fluorinated compound having poly(oxyperfluoroalkylene) chains and reactive silyl groups.

Further, in order to improve the adhesion between the substrate and the water and oil repellent layer, an underlayer is provided between them. For example, Patent Document 1 discloses that a silicon oxide layer is provided between the substrate and the water and oil repellent layer.

### PRIOR ART DOCUMENT

### Patent Document

Patent Document 1: JP-A-2014-218639

### DISCLOSURE OF INVENTION

### Technical Problem

In recent years, the performance requirements for a water and oil repellent layer formed by using a fluorinated compound have become higher. For example, when the water and oil repellent layer is applied to a component that constitutes a surface that is touched by fingers, a water and oil repellent layer, of which the performance (e.g. water repellency) is less likely to decrease even by repeated abrasion, i.e. a water and oil repellent layer excellent in abrasion resistance, is required.

When the present inventors have evaluated an article provided with a water and oil repellent layer, in which an underlayer containing silicon oxide, and a water and oil repellent layer formed by using a fluorinated compound were formed in this order, as described in Patent Document 1, on a metal surface of a substrate having the metal surface containing gold, silver, copper, etc., they have found that there is room for improvement in the abrasion resistance of the water and oil repellent layer.

Therefore, the present invention has an object to provide a fluorinated ether compound capable of forming a water and oil repellent layer excellent in abrasion resistance on a metal surface of a substrate having the metal surface containing a metal such as gold, silver, copper, etc., a composition, and an article provided with a water and oil repellent layer.

### Solution to Problem

As a result of a diligent study of the above problem, the present inventors have found that if a fluorinated ether compound represented by the formula (1-1) or formula (1-2) as described later, having a thiol structure or thioether structure, is used, it is possible to form a water and oil repellent layer excellent in abrasion resistance on a metal surface of the substrate, and thus have arrived at the present invention.

That is, the present inventors have found that the above problem can be solved by the following construction.

[1] A fluorinated ether compound characterized by being represented by the formula (1-1):

[R^{f}—(OX)ₘ—O—]ⱼ₁Y¹—Z¹[-L¹-S—R¹¹]_{g11}[R¹²]_{g12} (1-1)

in the formula (1-1),

R^{f} is a perfluoroalkyl group,

X is a fluoroalkylene group having at least one fluorine atom,

m is an integer of at least 2,

Y¹ is a single bond or a (j1+1) valent linking group,

Z¹ is a (g11+g12+1) valent linking group,

L¹ is a single bond or a divalent linking group,

R¹¹ is a hydrogen atom or a monovalent substituent,

R¹² is a monovalent substituent,

j1 is an integer of at least 1,

g11 is an integer of at least 2, and

g12 is an integer of at least 0.

[2] The fluorinated ether compound according to [1], wherein g11 in the formula (1-1) is an integer of at least 3.

[3] A fluorinated ether compound characterized by being represented by the formula (1-2):

[R²¹]_{g21}[R²²—S-L²¹-]_{g22}Z²¹—Y²¹—(OX)ₘ—O—Y²²—Z²²[-L²²-S—R²³]_{g23}[R²⁴]_{g24} (1-2)

in the formula (1-2),

R²¹ and R²⁴ are each independently a monovalent substituent,

R²² and R²³ are each independently a hydrogen atom or a monovalent substituent,

L²¹ and L²² are each independently a single bond or a divalent linking group,

Z²¹ is a (g21+g22+1) valent linking group,

Z²² is a (g23+g24+1) valent linking group,

Y²¹ and Y²² are each independently a single bond or a divalent linking group,

X is a fluoroalkylene group having at least one fluorine atom,

m is an integer of at least 2,

g21 and g24 are each independently an integer of at least 0, and

g22 and g23 are each independently an integer of at least 2,

provided that neither Y²¹ nor Y²² contains at least two ester bonds.

[4] The fluorinated ether compound according to [3], wherein g22 and g23 in the above formula (1-2) are each independently an integer of at least 3.

[5] A composition characterized by containing a fluorinated ether compound as claimed in any one of [1] to [4] and a liquid medium.

[6] A water and oil repellent agent comprising a fluorinated ether compound as claimed in any one of [1] to [4], or a composition as claimed in [5].

[7] The water and oil repellent agent according to [6], for forming a water and oil repellent layer on a metal surface of a substrate having the metal surface.

[8] The water and oil repellent agent according to [7], wherein said metal surface is a metal surface containing at least one metal selected from the group consisting of gold, silver and copper.

[9] A method for producing a substrate with a water and oil repellent layer, characterized by treating the surface of the substrate by a dry coating method using a fluorinated ether compound as defined in any one of [1] to [4], to form a water and oil repellent layer on the surface of the substrate.

[10] A method for producing a substrate with a water and oil repellent layer, characterized by applying said composition to the surface of the substrate by a wet coating method using the composition as claimed in [5], followed by drying to form a water and oil repellent layer on the surface of the substrate.

[11] An article provided with a water and oil repellent layer, characterized by comprising a substrate having a metal surface, and a water and oil repellent layer formed on the metal surface of the substrate, from a fluorinated ether compound as claimed in any one of [1] to [4] or a composition as claimed in [5].

[12] The article provided with a water and oil repellent layer according to [11], wherein the substrate having a metal surface is a substrate having a surface comprising at least one metal selected from the group consisting of gold, silver and copper.

### Advantageous Effects of Invention

According to the present invention, it is possible to provide a fluorinated ether compound capable of forming a water and oil repellent layer excellent in abrasion resistance on a metal surface of a substrate having the metal surface, a composition containing the fluorinated ether compound, and a substrate or article provided with a water and oil repellent layer.

### DESCRIPTION OF EMBODIMENTS

In this specification, a compound represented by the formula (1-1) is referred to as a compound (1-1). Compounds represented by other formulas will be referred to in the same manner. A group represented by the formula (g1-1) is referred to as a group (g1-1). Groups represented by other formulas will be referred to in the same manner.

In this specification, when it is said that “an alkylene group may have an A group”, the alkylene group may have an A group between carbon-carbon atoms in the alkylene group, or it may have an A group at the terminal, like an alkylene group-A group.

In this specification, a “linking group” refers not only to a collection of atoms, but also an atom itself will be treated as a “linking group” if it has a function of linking predetermined groups together. For example, a nitrogen atom itself will be treated as a trivalent linking group.

The meaning of the term in the present invention is as follows.

The “number average molecular weight” (Mn) of a compound is calculated by determining the number (average value) of oxyfluoroalkylene groups based on the terminal group by ¹H-NMR and ¹⁹F-NMR.

### [Fluorinated Ether Compound]

The fluorinated ether compound of the present invention will be explained for each embodiment.

### First Embodiment

The fluorinated ether compound of the first embodiment of the present invention is the compound represented by the formula (1-1) as described below (compound (1-1)), which has a thiol structure or a thioether structure.

The present inventors have found that when a water and oil repellent layer is formed by using a compound (1-1) on a substrate containing gold, silver or copper, the water and oil repellent layer is excellent in abrasion resistance. The details of the reason for this have not been clarified, but it is assumed to be due to the following reason.

In a case where the compound (1-1) has a thiol structure, the thiol structure part is considered to form a bond with the gold, silver or copper contained in the substrate. Further, in a case where the compound (1-1) has a thioether structure, the thioether structure part is considered to interact with the gold, silver or copper contained in the substrate. This is presumed to result in good adhesion between the water and oil repellent layer and the substrate, resulting in a water and oil repellent layer excellent in abrasion resistance.

The compound (1-1) is a fluorinated ether compound represented by the formula (1-1).

[R^{f}—(OX)ₘ—O—]ⱼ₁Y¹—Z¹[-L¹-S—R¹¹]_{g11}[R¹²]_{g12} (1-1)

In the formula (1-1), R^{f} is a perfluoroalkyl group.

The number of carbon atoms in the perfluoroalkyl group is preferably from 1 to 20, more preferably from 1 to 10, further preferably from 1 to 6, particularly preferably from 1 to 3, from such a viewpoint that the abrasion resistance of the water and oil repellent layer will be superior.

The perfluoroalkyl group may be linear, branched-chain, or cyclic.

As the perfluoroalkyl group, CF₃—, CF₃CF₂—, CF₃CF₂CF₂—, CF₃CF₂CF₂CF₂—, CF₃CF₂CF₂CF₂CF₂—, CF₃CF₂CF₂CF₂CF₂CF₂—, CF₃CF(CF₃)—, etc. may be mentioned.

As the perfluoroalkyl group, from such a viewpoint that the water and oil repellency of the water and oil repellent layer will be superior, CF₃—, CF₃CF₂— or CF₃CF₂CF₂— is preferred.

In the formula (1-1), (OX)ₘ is a poly(oxyfluoroalkylene) chain.

X is a fluoroalkylene group having at least one fluorine atom.

The number of carbon atoms in the fluoroalkylene group is preferably from 1 to 6, particularly preferably from 2 to 4, from such a viewpoint that weatherability and corrosion resistance of the water and oil repellent layer will be superior.

The fluoroalkylene group may be linear, branched-chain, or cyclic.

The fluoroalkylene group has at least one fluorine atom, and from such a viewpoint that the corrosion resistance of the water and oil repellent layer will be superior, from 2 to 10 fluorine atoms are preferred, and from 2 to 4 fluorine atoms are particularly preferred.

As the fluoroalkylene group, a group (perfluoroalkylene group) in which all the hydrogen atoms in the fluoroalkylene group are replaced with fluorine atoms, is preferred.

As specific examples of (OX), —OCHF—, —OCF₂CHF—, —OCHFCF₂—, —OCF₂CH₂—, —OCH₂CF₂—, —OCF₂CF₂CHF—, —OCHFCF₂CF₂—, —OCF₂CF₂CH₂—, —OCH₂CF₂CF₂—, —OCF₂CF₂CF₂CH₂—, —OCH₂CF₂CF₂CF₂—, —OCF₂CF₂CF₂CF₂C—OCH₂CF₂CF₂CF₂CF₂—, —OCF₂CF₂CF₂CF₂CF₂CH₂—, —OCH₂CF₂CF₂CF₂CF₂CF₂—, —OCF₂CF₂—, —OCF₂CF₂CF₂—, —OCF(CF₃)CF₂—, —OCF₂CF₂CF₂CF₂—, —OCF(CF₃)CF₂CF₂—, —OCF₂CF₂CF₂CF₂C—OCF₂CF₂CF₂CF₂CF₂C—O-cycloC₄F₆—, and —O-cycloC₆F₁₀— may be mentioned.

Here, -cycloC₄F₆— means a perfluorocyclobutanediyl group, and its specific example may be perfluorocyclobutane-1,2-diylgroup. -cycloC₆F₁₀- means a perfluorocyclohexanediyl group, and its specific example may be perfluorocyclohexane-1,4-diyl group.

m is an integer of at least 2, more preferably from 2 to 200, further preferably from 5 to 150, particularly preferably from 5 to 100, most preferably from 10 to 50.

(OX)ₘ may contain only one type of (OX) or at least 2 types of (OX).

The bonding order of at least 2 types of (OX) is not limited, and they may be arranged randomly, alternately, or in blocks.

Containing at least 2 types of (OX) means that in the compound (1-1), at least 2 types of (OX) different in the number of carbon atoms, are present, at least 2 types of (OX) different in the number of hydrogen atoms, are present, at least 2 types of (OX) different in positions of hydrogen atoms, are present, and at least 2 types of (OX) with the same number of carbon atoms but different in the presence or absence of side chains or types of side chains (the number of side chains, the number of carbon atoms in side chains, etc.) are present.

With respect to the arrangement of at least 2 types of (OX), for example, the structure represented by {(OCF₂)ₘ₂₁.(OCF₂CF₂)ₘ₂₂}, shows that m21 (OCF₂) and m22 (OCF₂CF₂) are randomly arranged. Further, the structure represented by (OCF₂CF₂—OCF₂CF₂CF₂CF₂)ₘ₂₅ shows that m25 (OCF₂CF₂) and m25 (OCF₂CF₂CF₂CF₂) are alternately arranged.

As (OX)ₘ, [(OCHₘₐF₍₂₋ₘₐ₎)ₘ₁₁.(OC₂F_{mb}F_{(4-mb)})ₘ₁₂.(OC₃H_{mc}F_{(6-mc)})ₘ₁₃.(OC₄F_{md}F_{(8-md)})ₘ₁₄.(OC₅HₘₑF₍₁₀₋ₘₑ₎)ₘ₁₅(OC₆H_{mf}F_{(12-mf)})ₘ₁₆.(O-CyClOC₄H_{mg}F_{(6-mg)})ₘ₁₇.(O-CycloC₆HₘₕF₍₁₀₋ₘₕ₎)ₘ₁₈] is preferred. Here, -cycloC₄H_{mg}F_{(6-mg)} represents a fluorocyclobutanediyl group, and a fluorocyclobutane-1,2-diylgroup is preferred. -cycloC₆HₘₕF₍₁₀₋ₘₕ₎ represents a fluorocyclohexanediyl group, and a fluorocyclohexane-1,4-diyl group is preferred.

ma is 0 or 1, mb is an integer of from 0 to 3, and mc is an integer of from 0 to 5, and is an integer of from 0 to 7, me is an integer of from 0 to 9, mf is an integer of from 0 to 11, mg is an integer of from 0 to 5, and mh is an integer of from 0 to 9.

m11, m12, m13, m14, m15, m16, m17 and m18 are each independently an integer of at least 0, and at most 100 is preferred.

m11+m12+m13+m14+m15+m16+m17+m18 is an integer of at least 2, and from 2 to 200 is more preferred, from 5 to 150 is further preferred, from 5 to 100 is particularly preferred, and from 10 to 50 are most preferred.

Among them, m12 is preferably at least 2, and from 2 to 200 is particularly preferred.

Further, C₃H_{mc}F_{(6-mc)}, C₄H_{md}F_{(8-md)}, C₅HₘₑF₍₁₀₋ₘₑ₎ and C₆H_{mf}F_{(12-mf)} may be linear or branched chains, and from such a viewpoint that the abrasion resistance of the water and oil repellent layer will be superior, linear is preferred.

Further, the bonding order of m11 (OCHₘₐF₍₂₋ₘₐ₎), m12 (OC₂H_{mb}F_{(4-mb)}), m13 (OC₃H_{mc}F_{(6-mc)}), m14 (OC₄H_{md}F_{(8-md)}, m15 (OC₅HₘₑF₍₁₀₋ₘₑ₎, m16 (OC₆H_{mf}F_{(12-mf)}), m17 (O-cycloC₄H_{mg}F_{(6-mg)}), m18 (O-cycloC₆HₘₕF₍₁₀₋ₘₕ₎), is not limited.

In a case where m11 is at least 2, the plurality of (OCHₘₐF₍₂₋ₘₐ₎) may be different.

In a case where m12 is at least 2, the plurality of (OC₂H_{mb}F_{(4-mb)}) may be different.

In a case where m13 is at least 2, the plurality of (OC₃H_{mc}F_{(6-mc)}) may be different.

In a case where m14 is at least 2, the plurality of (OC₄H_{md}F_{(8-md)}) may be different.

In a case where m15 is at least 2, the plurality of (OC₅HₘₑF₍₁₀₋ₘₑ₎) may be different.

In a case where m16 is at least 2, the plurality of (OC₆H_{mf}F_{(12-mf)}) may be different.

In a case where m17 is at least 2, the plurality of (O-cycloC₄H_{mg}F_{(6-mg)}) may be different.

In a case where m18 is at least 2, the plurality of (O-cycloC₆HₘₕF₍₁₀₋ₘₕ₎) may be different.

(OX)ₘ is preferably those having the following structures.

{(OCF₂)ₘ₂₁.(OCF₂CF₂)ₘ₂₂},

(OCF₂CF₂)ₘ₂₃,

(OCF₂CF₂CF₂)ₘ₂₄,

(OCF₂CF₂—OCF₂CF₂CF₂CF₂)ₘ₂₅,

{(OCF₂CF₂CF₂CF₂CF₂)ₘ₂₆.(OCF₂)ₘ₂₇},

{(OCF₂CF₂CF₂CF₂CF₂)ₘ₂₆.(OCF₂CF₂)ₘ₂₇},

{(CF₂CF₂CF₂CF₂CF₂CF₂)ₘ₂₆.(OCF₂)ₘ₂₇},

{(OCF₂CF₂CF₂CF₂CF₂CF₂)ₘ₂₆.(OCF₂CF₂)ₘ₂₇},

(OCF₂CF₂CF₂CF₂CF₂—OCF₂)ₘ₂₈,

(OCF₂CF₂CF₂CF₂CF₂—OCF₂CF₂)ₘ₂₈,

(OCF₂CF₂CF₂CF₂CF₂CF₂—OCF₂)ₘ₂₈,

(OCF₂CF₂CF₂CF₂CF₂CF₂—OCF₂CF₂)ₘ₂₈,

(OCF₂—OCF₂CF₂CF₂CF₂CF₂)ₘ₂₈,

(OCF₂—OCF₂CF₂CF₂CF₂CF₂CF₂)ₘ₂₈,

(OCF₂CF₂—OCF₂CF₂CF₂CF₂CF₂)ₘ₂₈,

(OCF₂CF₂—OCF₂CF₂CF₂CF₂CF₂CF₂)ₘ₂₈.

Here, m21 is an integer of at least 1, m22 is an integer of at least 1, m21+m22 is an integer of from 2 to 500, m23 and m24 are each independently an integer of from 2 to 500, m25 is an integer of from 1 to 250, m26 and m27 are each independently an integer of at least 1, m26+m27 is an integer of from 2 to 500, and m28 is an integer of from 1 to 250.

(OX)ₘ is more preferably those having the following structures from such a viewpoint that the production of the compound (1-1) will be easy.

{(OCF₂)ₘ₂₁.(OCF₂CF₂)ₘ₂₂},

(OCF₂CF₂CF₂)ₘ₂₄,

(OCF₂CF₂)₂{(OCF₂)ₘ₂₁.(OCF₂CF₂)ₘ₂₂₋₂},

(OCF₂CF₂—OCF₂CF₂CF₂CF₂)ₘ₂₅₋₁OCF₂CF₂,

(OCF₂CF₂CF₂CF₂CF₂—OCF₂)ₘ₂₈,

(OCF₂CF₂CF₂CF₂CF₂CF₂—OCF₂)ₘ₂₈,

(OCF₂CF₂—OCF₂CF₂CF₂CF₂CF₂)ₘ₂₈₋₁OCF₂CF₂,

(OCF₂CF₂—OCF₂CF₂CF₂CF₂CF₂CF₂)ₘ₂₈₋₁OCF₂CF₂.

Here, with respect to m22-2, m25-1 and m28-1, so that they become integers of at least 1, the numbers of m22, m25 and m28 are selected.

Among these, from such a viewpoint that the abrasion resistance of the water and oil repellent layer will be superior, (OX)ₘ is preferably {(OCF₂)ₘ₂₁.(OCF₂CF₂)ₘ₂₂}.

In {(OCF₂)ₘ₂₁.(OCF₂CF₂)ₘ₂₂}, m22/m21, is preferably from 0.1 to 10, more preferably from 0.2 to 5.0, further preferably from 0.2 to 2.0, particularly preferably from 0.2 to 1.5, most preferably from 0.2 to 0.85, from such a viewpoint that the abrasion resistance and fingerprint smudge cleanability of the water and oil repellent layer will be superior.

Y¹ is a single bond or a (j1+1) valent linking group. As will be described later, j1 is preferably 1, and when j1 is 1, Y¹ represents a divalent linking group.

As specific examples of the (j1+1) valent linking group, a hydrocarbon group, and a group having —C(O)NR⁶—, —C(O)—, —NR⁶—, —OC(O)O—, —NHC(O)O—, —NHC(O)NR⁶—, —O— or —SO₂NR⁶— between carbon-carbon atoms in a hydrocarbon group with at least 2 carbon atoms, may be mentioned. R⁶ is a hydrogen atom, a C₁₋₆ alkyl group or a phenyl group.

As the hydrocarbon group, an aliphatic hydrocarbon group (which may be saturated or unsaturated) and an aromatic hydrocarbon group are preferred; an aliphatic hydrocarbon group is more preferred; and an alkylene group is particularly preferred.

The aliphatic hydrocarbon group may be linear, branched-chain, or cyclic, and is preferably linear or branched-chain.

The number of carbon atoms in the hydrocarbon group is preferably from 1 to 10, particularly preferably from 1 to 5.

In a specific example of the (j1+1) valent linking group, the bonding order is not particularly limited, and for example, in a case where Y¹ is a group having —C(O)NR⁶— between carbon-carbon atoms in a hydrocarbon group with at least 2 carbon atoms, the carbon atom of —C(O)NR⁶— may be bonded to the Z¹ side of the formula (1-1), or the nitrogen atom of —C(O)NR⁶— may be bonded to the Z¹ side of the formula (1-1).

Z¹ is a (g11+g12+1) valent linking group. Here, as the (g11+g12+1) valent linking group, a trivalent to hexavalent linking group is preferred, and a trivalent linking group or a tetravalent linking group is particularly preferred.

As specific examples of the (g11+g12+1) valent linking group, a carbon atom, a nitrogen atom, a silicon atom, a ring having at least one of a nitrogen atom and a carbon atom (e.g. an isocyanurate ring), an organopolysiloxane residue, a hydrocarbon group having at least 2 carbon atoms which may have a substituent (preferably a halogen atom), a group having —O—, —C(O)NR⁶—, —C(O)— or —NR⁶— between carbon-carbon atoms in a hydrocarbon group with at least 2 carbon atoms, which may have a substituent (preferably a halogen atom), and a group represented by —CH(—*¹)—Si(—*¹)ᵢ₃(—*²)₃₋ᵢ₃ (where represents the bonding position to L¹ in the formula (1-1)), *² represents the bonding position to R¹² in the formula (1-1), and i3 is an integer of from 1 and 3), may be mentioned. R⁶ is a hydrogen atom, a C₁₋₆ alkyl group or a phenyl group.

As the hydrocarbon group, an aliphatic hydrocarbon group (which may be saturated or unsaturated) and an aromatic hydrocarbon group are preferred; an aliphatic hydrocarbon group is more preferred; and an alkylene group is particularly preferred.

The aliphatic hydrocarbon group may be linear, branched-chain, or cyclic, and is preferably linear or branched-chain.

The number of carbon atoms in the hydrocarbon group is preferably from 2 to 20, particularly preferably from 2 to 10.

L¹ is a single bond or a divalent linking group.

As specific examples of the divalent linking group, an alkylene and a phenylene group may be mentioned.

In a case where the number of carbon atoms in the alkylene group is at least 2, the alkylene group may have —C(O)NR⁶—, —C(O)—, —NR⁶—, —O— or —S— between carbon-carbon atoms. R⁶ is a hydrogen atom, a C₁₋₆ alkyl group or a phenyl group.

The carbon atom of the phenylene group may be bonded to —S— (i.e. L¹ is a group represented by —C₆H₄—S—, and the sulfur atom is bonded to Z¹).

The alkylene group may be linear, branched-chain or cyclic, and is preferably linear or branched-chain. As the number of carbon atoms in the alkylene group, from 1 to 20 is preferred, from 2 to 15 is more preferred, and from 3 to 10 is particularly preferred.

R¹¹ is a hydrogen atom or a monovalent substituent.

As a specific example of the monovalent substituent in R¹¹, an alkyl group, a group having a hydrogen atom in the alkyl group substituted by a group represented by —Si(R)ₙL₃₋ₙ, a carboxy group or a hydroxyl group, or a group having a carbon atom in an alkyl group substituted by a carbonyl group, may be mentioned.

The alkyl group may be linear, branched-chain or cyclic. The number of carbon atoms in the alkyl group is preferably from 1 to 30, more preferably from 1 to 20, particularly preferably from 1 to 10.

L is a hydrolyzable group or a hydroxy group. As specific examples of L being a hydrolyzable group, an alkoxy group, an aryloxy group, a halogen atom, an acyl group, an acyloxy group, and an isocyanate group (—NCO), may be mentioned. As the alkoxy group, a C₁₋₄ alkoxy group is preferred. As the aryloxy group, a C₃₋₁₀ aryloxy group is preferred. As the halogen atom, a chlorine atom is preferred. As the acyl group, a C₁₋₆ acyl group is preferred. As the acyloxy group, a C₁₋₆ acyloxy group is preferred. As L, a C₁₋₄ alkoxy group and a halogen atom are preferred.

R is a monovalent hydrocarbon group. As the monovalent hydrocarbon group, a monovalent aliphatic hydrocarbon group (which may be saturated or unsaturated) and an monovalent aromatic hydrocarbon group, are preferred; a monovalent aliphatic hydrocarbon group is more preferred; and an alkyl group is particularly preferred. The monovalent hydrocarbon group may be linear, branched-chain or cyclic, and is preferably linear or branched-chain. The number of carbon atoms in the monovalent hydrocarbon group is preferably from 1 to 6, more preferably from 1 to 3, particularly preferably from 1 to 2.

R¹² represents a monovalent substituent.

As specific examples of the monovalent substituent, an alkyl group, a hydroxy group, an acyloxy group and a halogen atom, may be mentioned; and a hydroxy group is preferred.

j1 is an integer of at least 1, and from such a viewpoint that the water and oil repellency of the water and oil repellent layer will be superior, from 1 to 6 is preferred, and 1 is particularly preferred.

g11 is an integer of at least 2, and from such a viewpoint that the abrasion resistance of the water and oil repellent layer will be superior, 3 or more is preferred. g11 is preferably at most 15, more preferably at most 8, particularly preferably at most 6.

g12 is an integer of at least 0, preferably from 0 to 3, more preferably from 0 to 1, and from such a viewpoint that the abrasion resistance of the water and oil repellent layer will be superior, 0 is particularly preferred.

The plurality of [-L¹-S—R¹¹] which the compound (1-1) has, may be different.

In a case where the compound (1-1) has a plurality of [R^{f}—(OX)ₘ—O—], the plurality of [R^{f}—(OX)ₘ—O—] may be different.

The portion represented by Y¹—Z¹ in the formula (1-1) is preferably a group represented by the following formula (g1-1) to formula (g1-8).

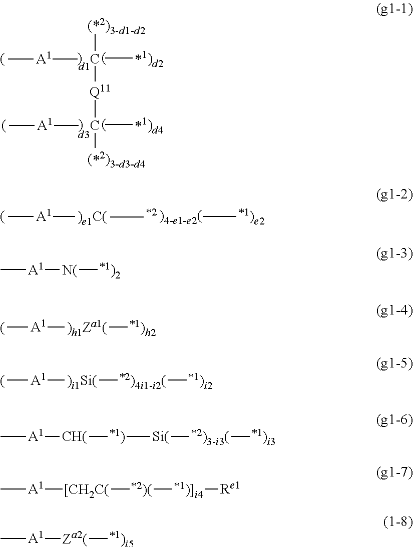

Here, in the formula (g1-1) to formula (g1-8), the symbols corresponding to j1 and g11 in the formula (1-1) and their definitions are as follows.

Formula (g1-1): j1=d1+d3, g11=d2+d4, d2+d4>2

Formula (g1-2): j1=e1, g11=e2, e2>2

Formula (g1-3): j1=1, g11=2

Formula (g1-4): j1=h1, g11=h2, h2>2

Formula (g1-5): j1=i1, g11=i2, i2>2

Formula (g1-6): j1=1, g11=i3+1, i3>1

Formula (g1-7): j1=1, g11=i4, i4>2

Formula (g1-8): j1=1, g11=i5, i5>2

In the formula (g1-1) to formula (g1-8), A¹ corresponds to Y¹ in the formula (1-1).

In the formula (g1-1) to formula (g1-8), *¹ means the bonding position to [-L¹-S—R¹¹] in the formula (1-1), and *² means the bonding position to [R¹²] in the formula (1-1).

A¹ is a single bond, an alkylene group, or a group having —C(O)NR⁶—, —C(O)—, —OC(O)O—, —NHC(O)O—, —NHC(O)NR⁶—, —O— or —SO₂NR⁶— between carbon-carbon atoms in an alkylene group with at least 2 carbon atoms. In each formula, if at least 2 A¹ are present, the at least 2 A¹ may be different. A hydrogen atom of the alkylene group may be replaced by a fluorine atom.

Q¹¹ is a single bond, —O—, an alkylene group, or a group having —C(O)NR⁶—, —C(O)—, —NR⁶—, or —O— between carbon-carbon atoms in an alkylene group with at least 2 carbon atoms.

Z^{a1} is a group having an h1+h2 valent ring structure having a carbon atom or nitrogen atom to which A¹ is directly bonded and a carbon atom or nitrogen atom to which [-L¹-S—R¹¹] is directly bonded. As a specific example of Z^{a1}, an isocyanurate ring may be mentioned.

Z^{a2} is a (i5+1) valent organopolysiloxane residue, and the following groups are preferred. Here, Ra in the following formulas is an alkyl group (preferably a C₁₋₁₀ alkyl group) or a phenyl group.

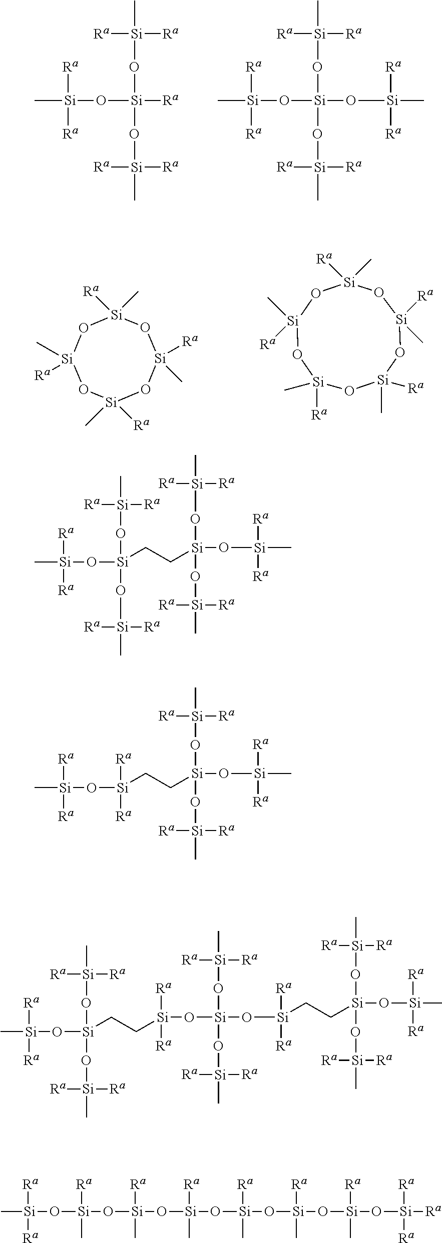

R^{e1} is either a hydrogen atom or a halogen atom, and is preferably a hydrogen atom from such a viewpoint that it will be easy to produce the compound.

d1 is an integer of from 0 to 3, preferably 1 or 2. d2 is an integer of from 0 to 3, preferably 1 or 2. d1+d2 is an integer of from 1 to 3.

d3 is an integer of from 0 to 3, preferably 0 or 1. d4 is an integer of from 0 to 3, preferably 2 or 3. d3+d4 is an integer of from 1 to 3.

d1+d3 is an integer of from 1 to 5, preferably 1 or 2, more preferably 1.

d2+d4 is an integer of from 2 to 5, preferably 4 or 5.

e1+e2 is 3 or 4. e1 is 1 or 2. e2 is 2 or 3.

h1 is an integer of at least 1, preferably from 1 to 6, more preferably from 1 to 4, further preferably 1 or 2, particularly preferably 1. h2 is an integer of at least 2, preferably from 2 to 6, more preferably from 2 to 4, particularly preferably 2 or 3.

i1+i2 is 3 or 4. i1 is an integer of at least 1, preferably from 1 to 2, more preferably 1. i2 is an integer of at least 2, preferably 2 or 3.

i3 is an integer of from 1 to 3, preferably 2 or 3.

i4 is an integer of at least 2, preferably from 2 to 10, particularly preferably from 2 to 6.

i5 is an integer of from 2 to 7.

Specific examples of the compound (1-1) are shown below.

As the compound (1-1) in which the portion represented by Y¹—Z¹ in the formula (1-1) is the group (g1-2), for example, compounds of the following formulas may be mentioned.

Here, PFPE in the following compounds represents R^{f}—(OX)ₘ₊₁. The definitions of R_{f}, X and m are as described above.

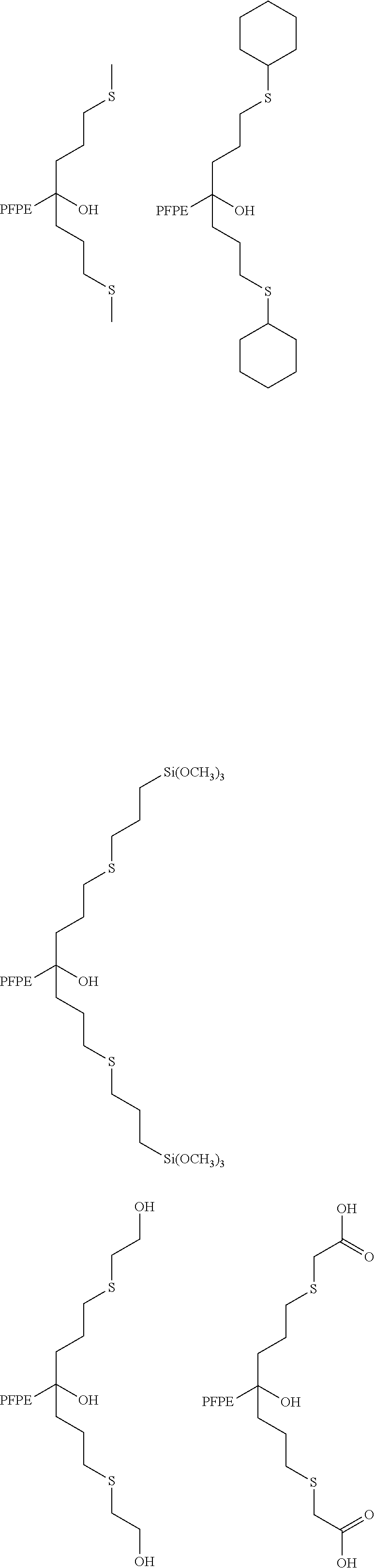

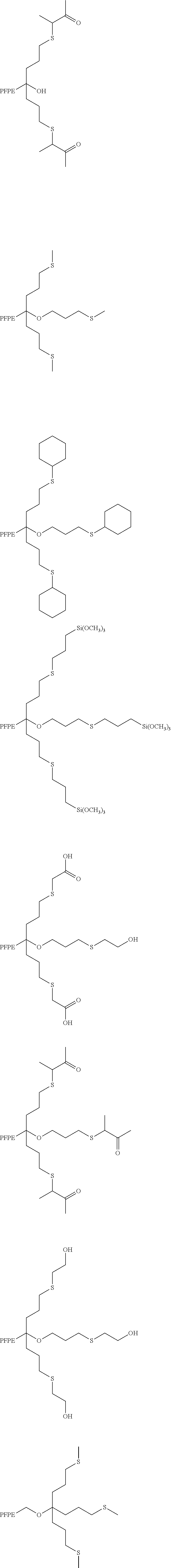

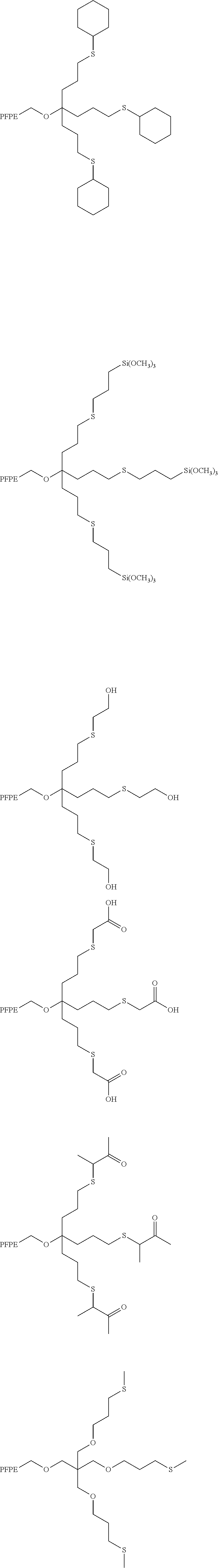

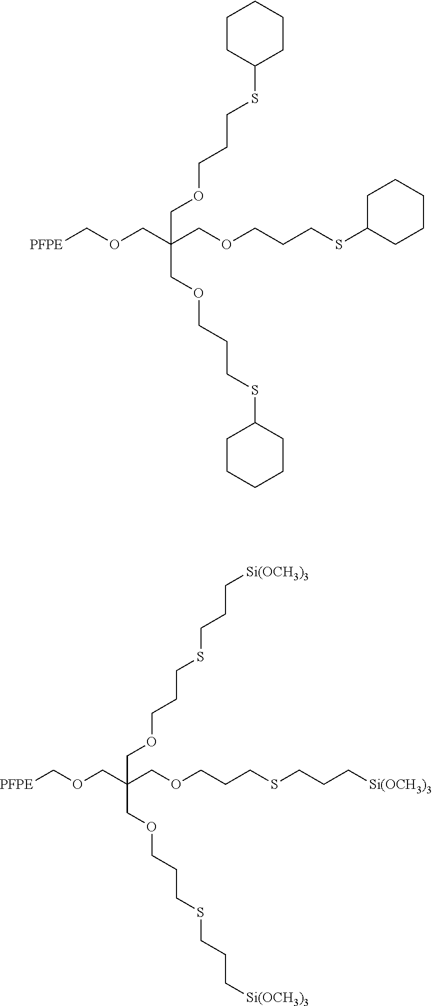

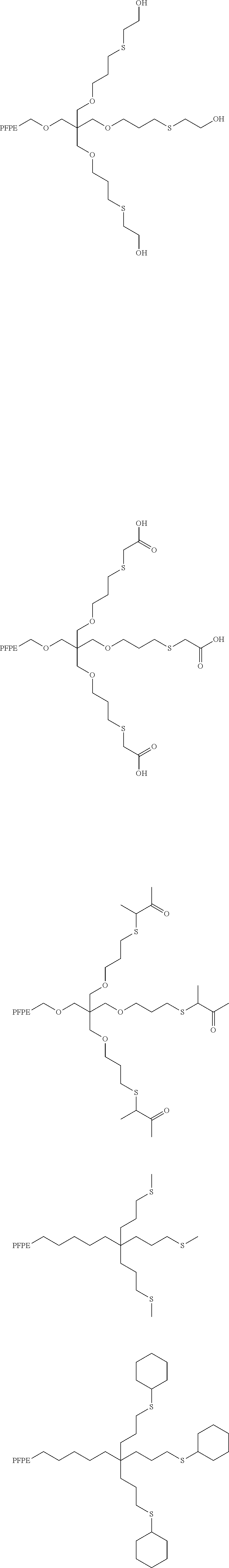

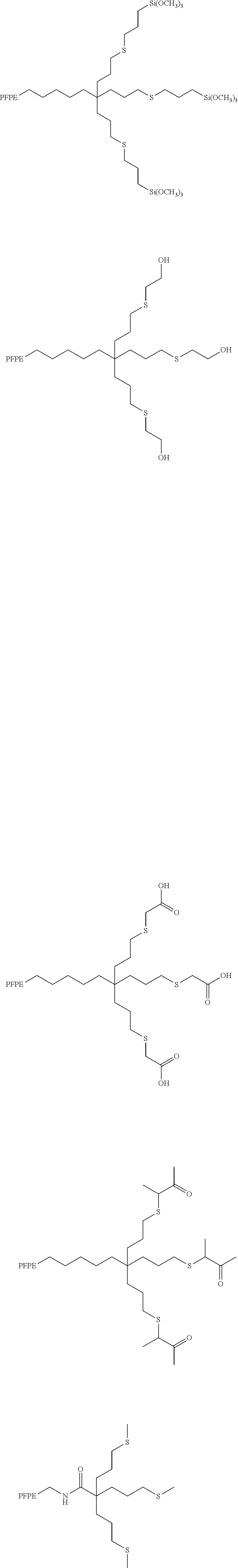

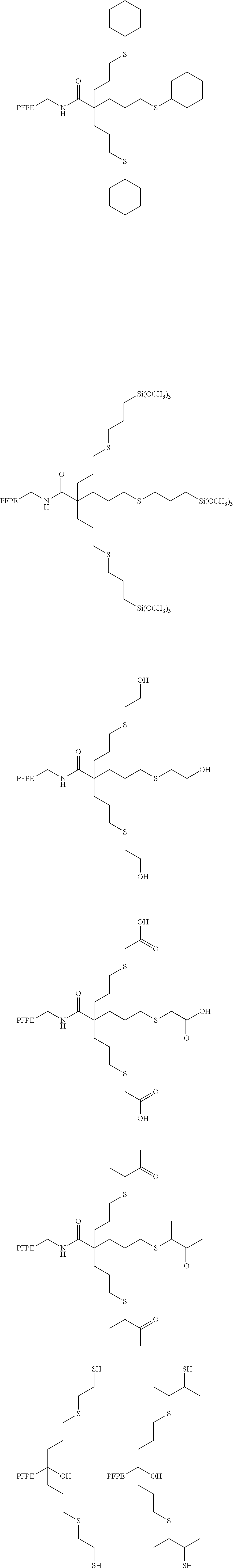

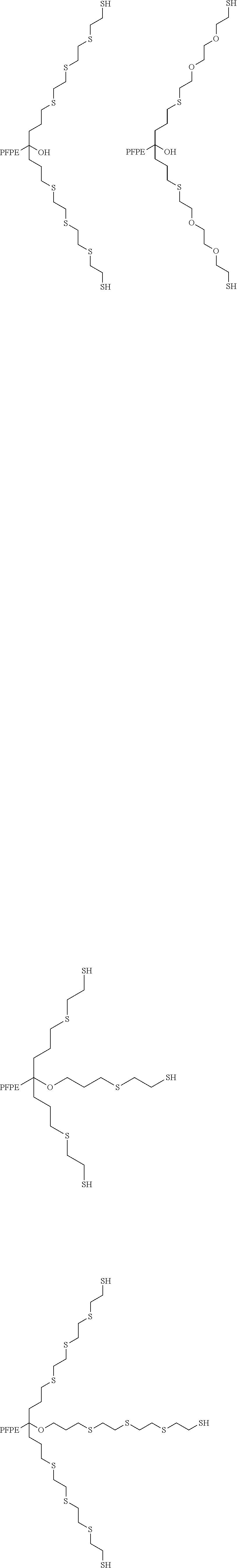

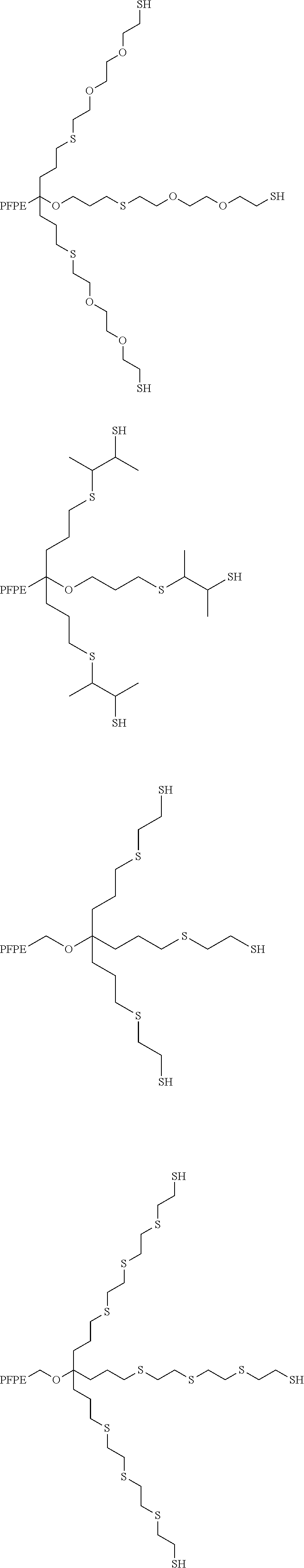

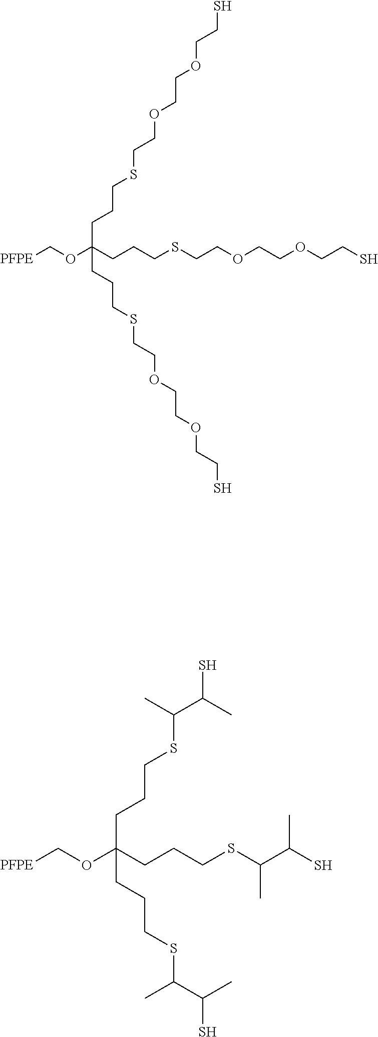

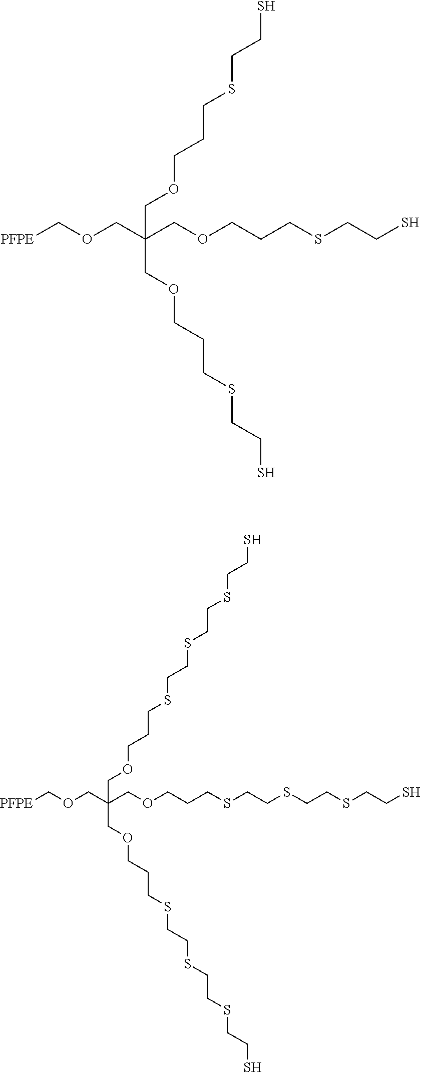

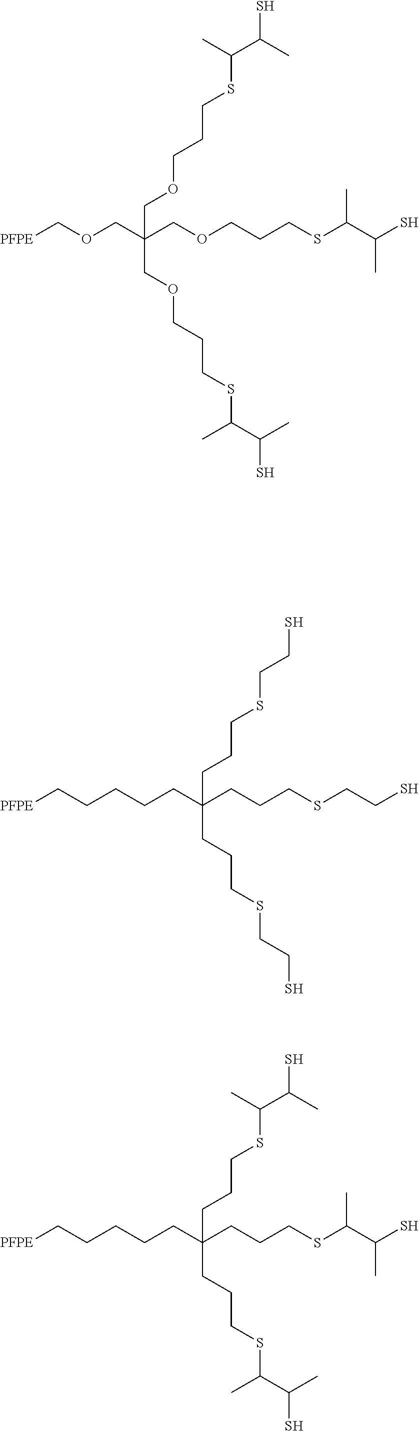

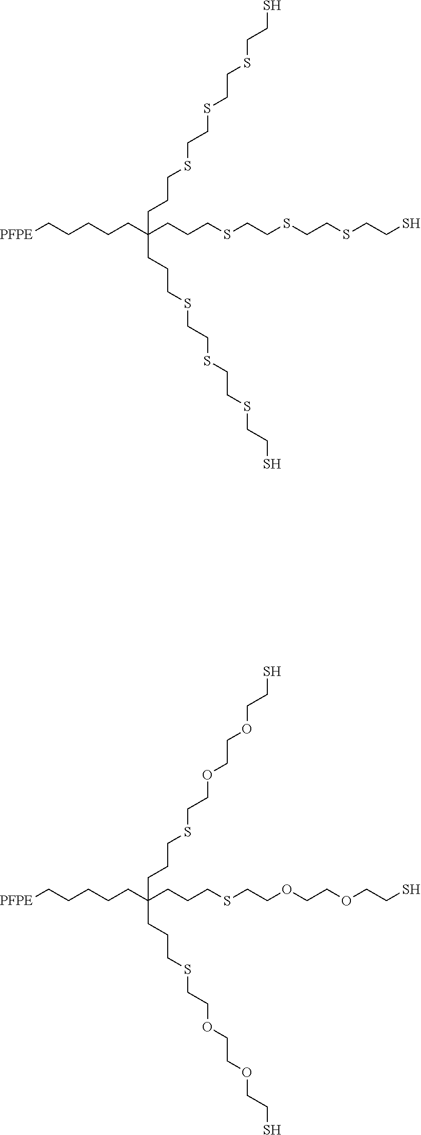

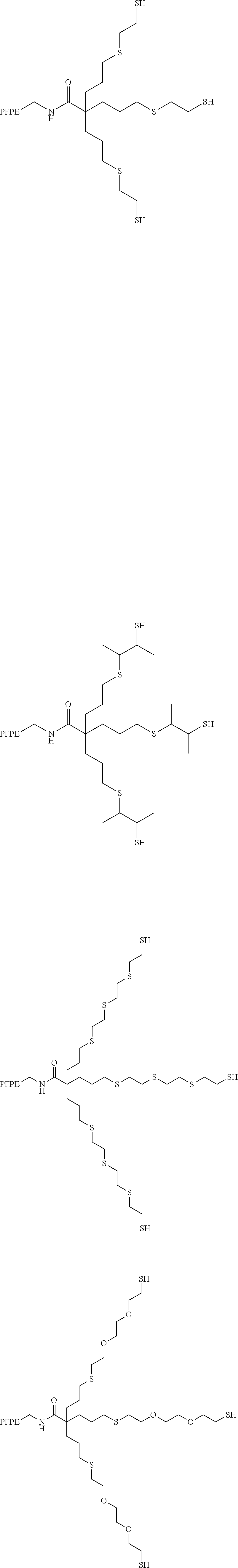

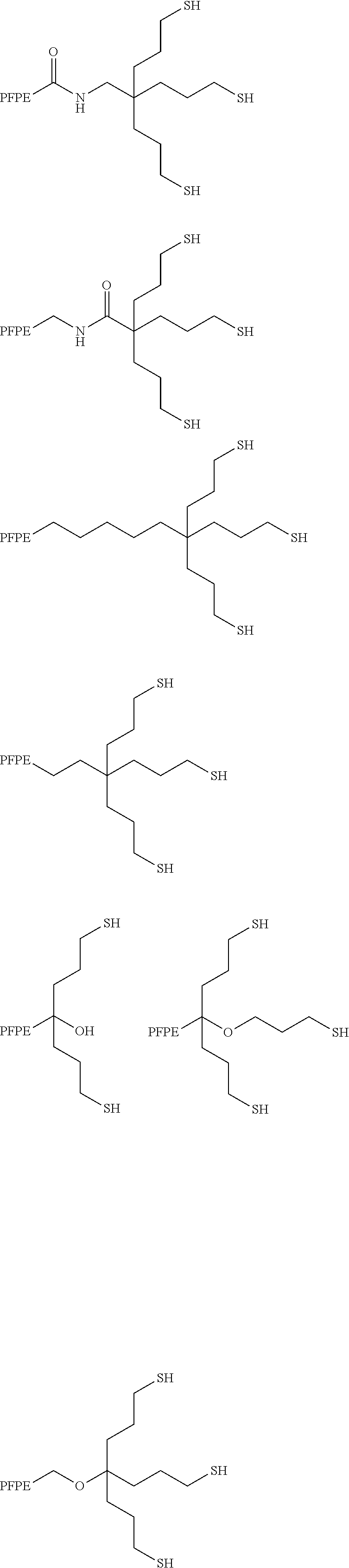

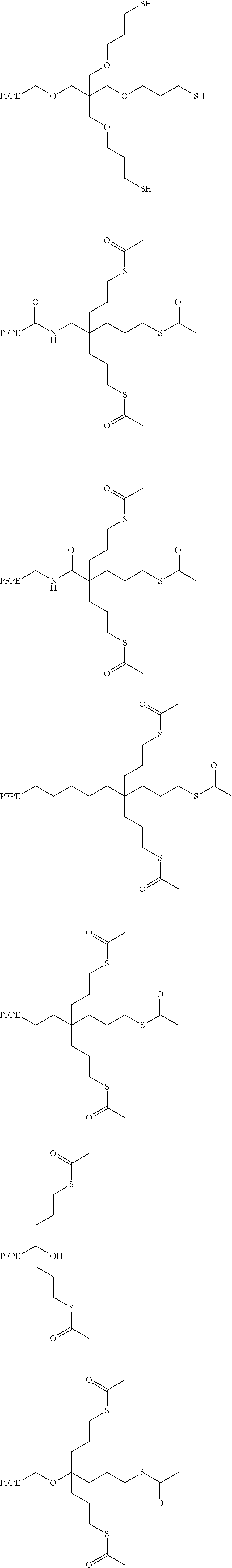

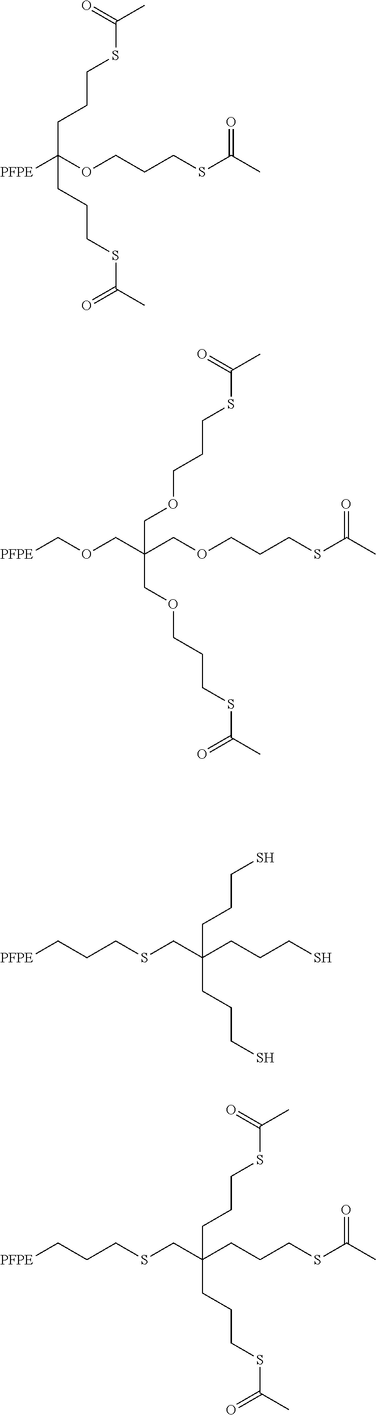

As the compound (1-1) in which the portion represented by Y¹—Z¹ in the formula (1-1) is the group (g1-4), for example, the compounds of the following formulas may be mentioned.

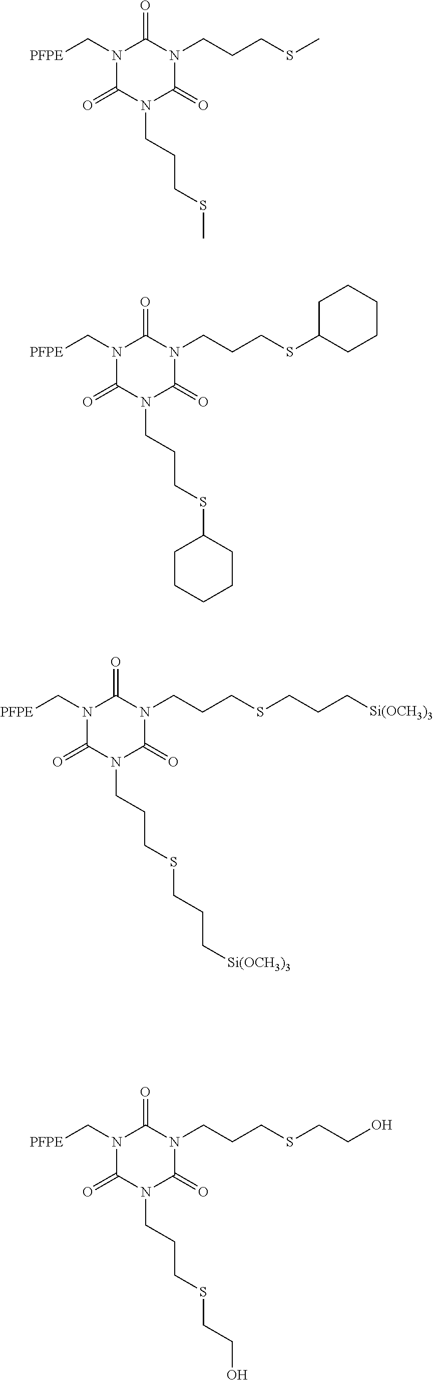

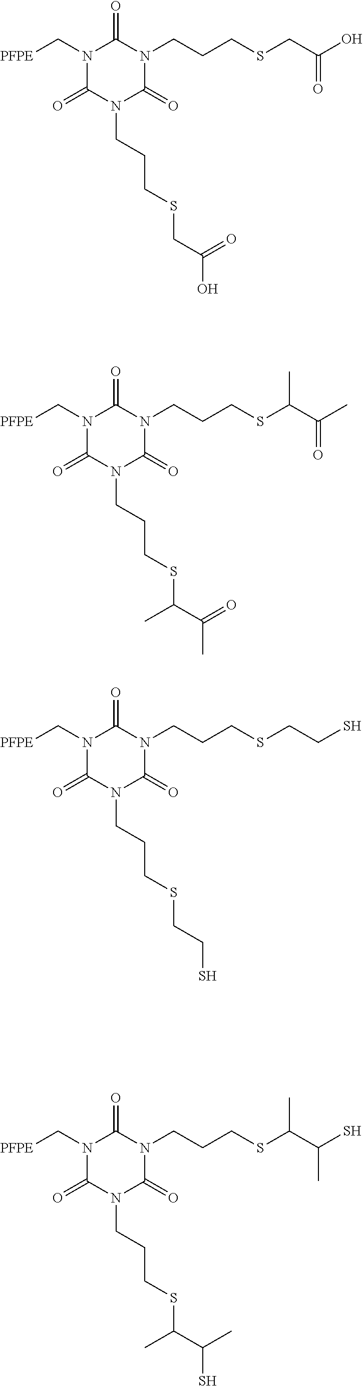

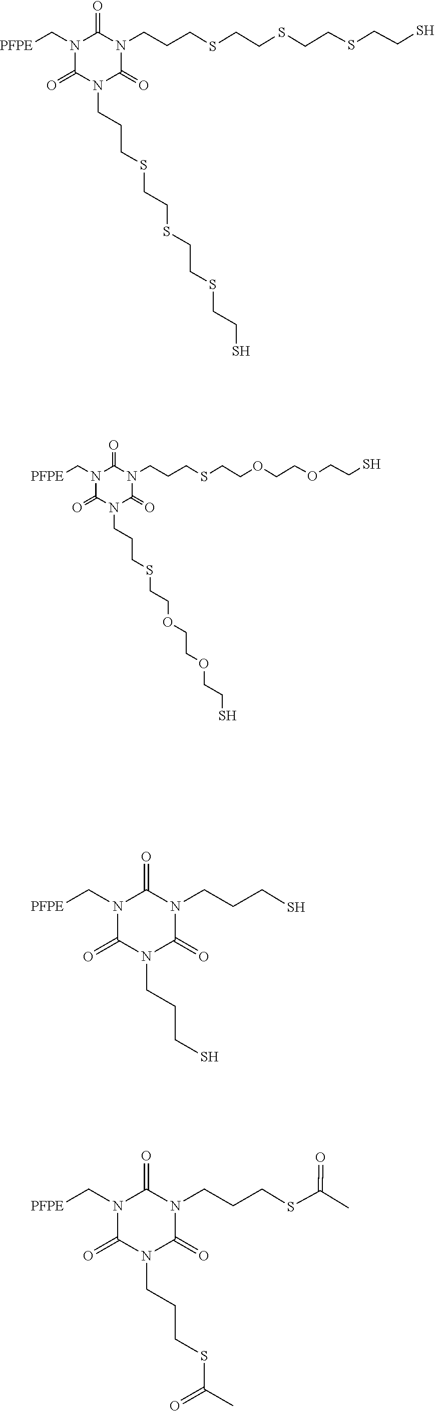

As the compound (1-1) in which the portion represented by Y¹—Z¹ in the formula (1-1) is the group (g1-5), for example, the compounds of the following formulas may be mentioned.

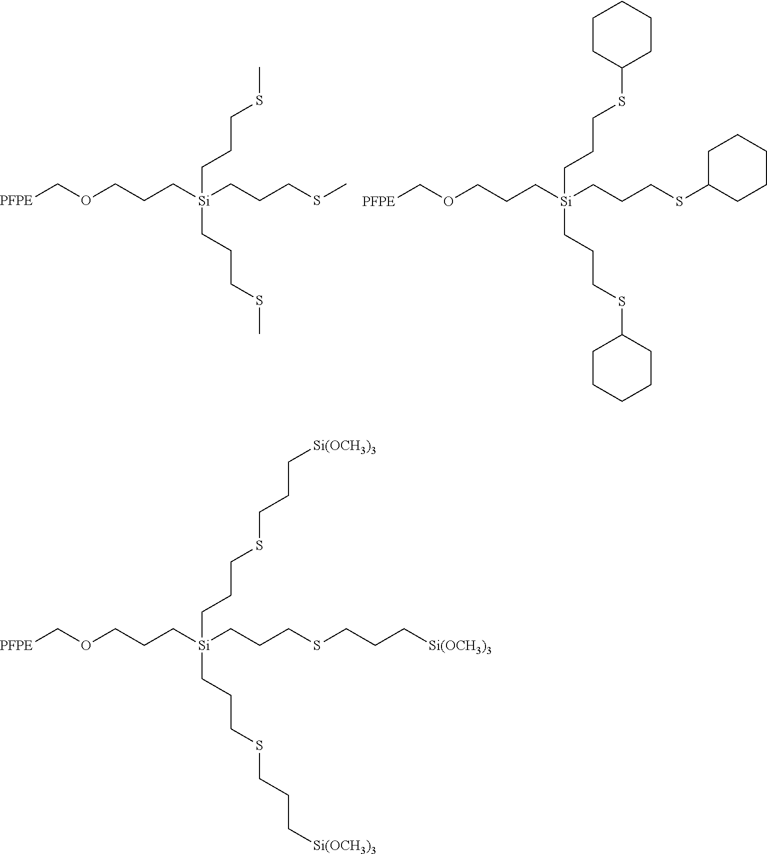

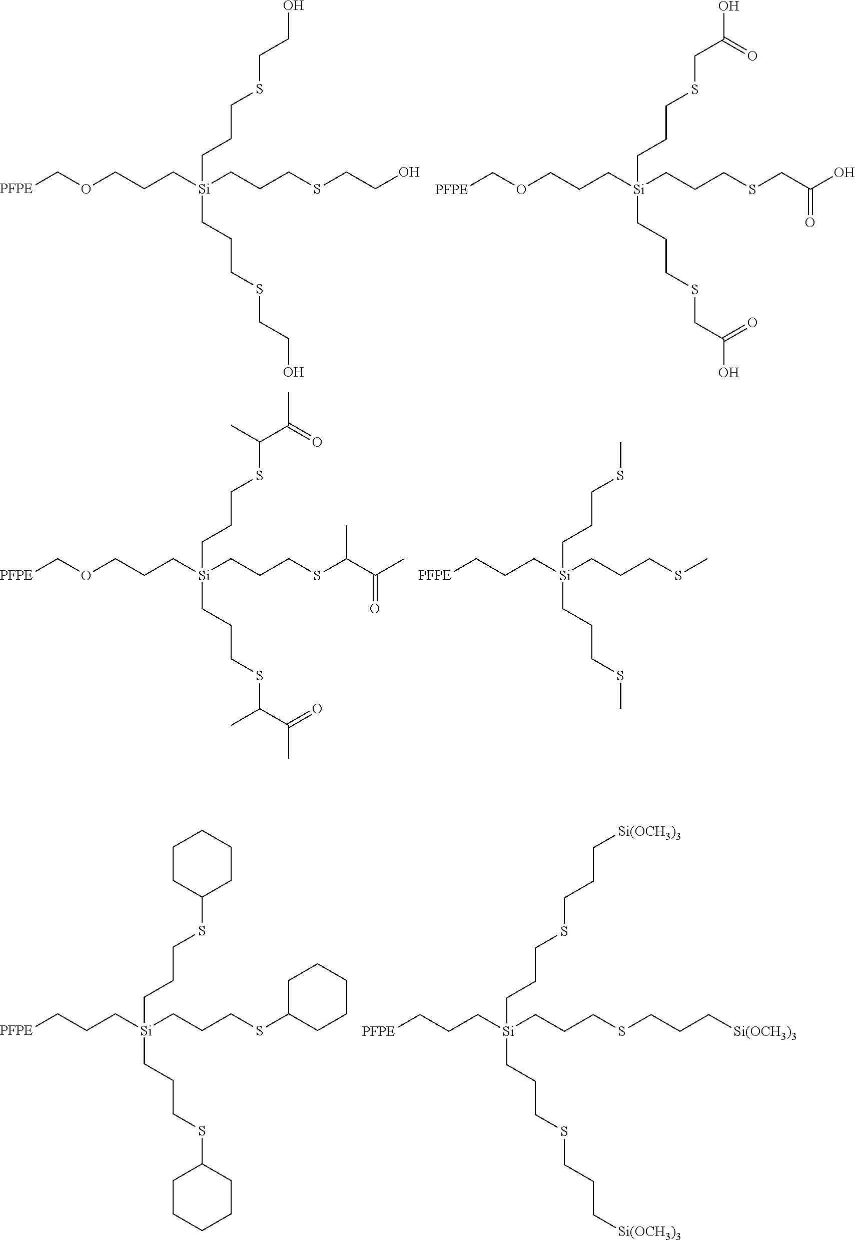

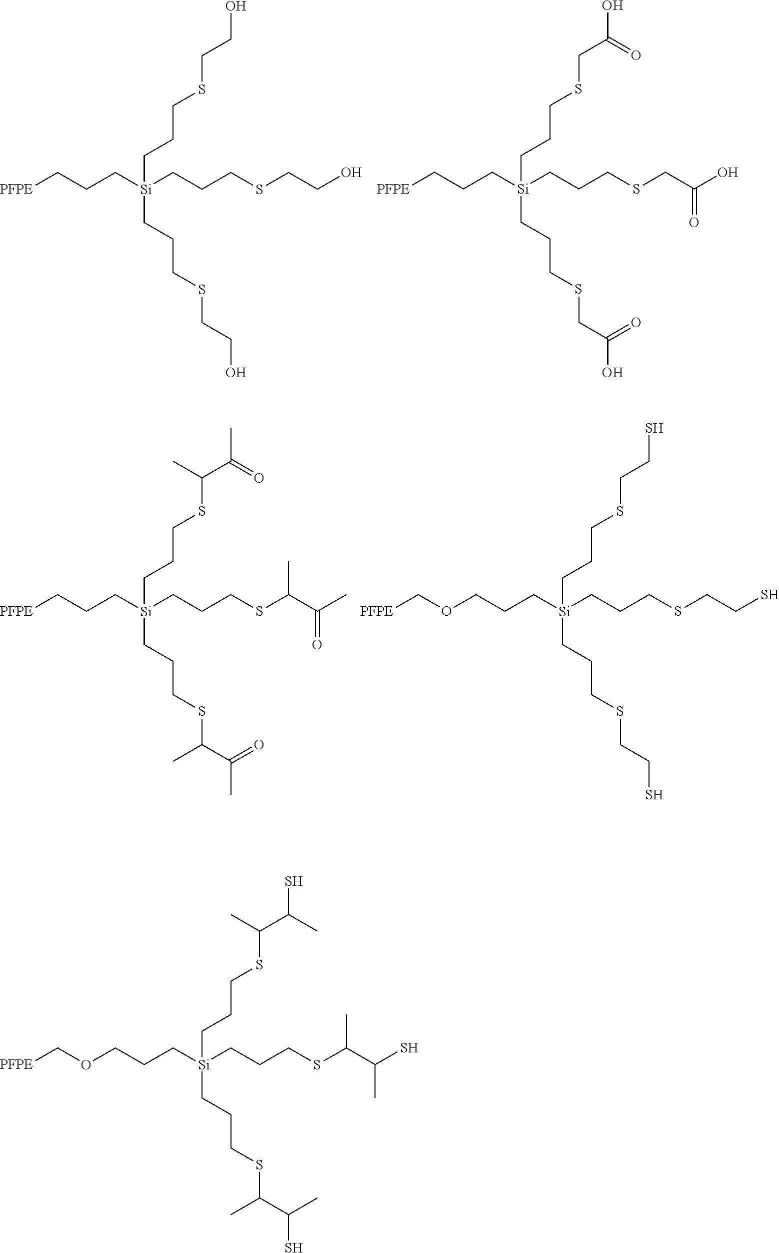

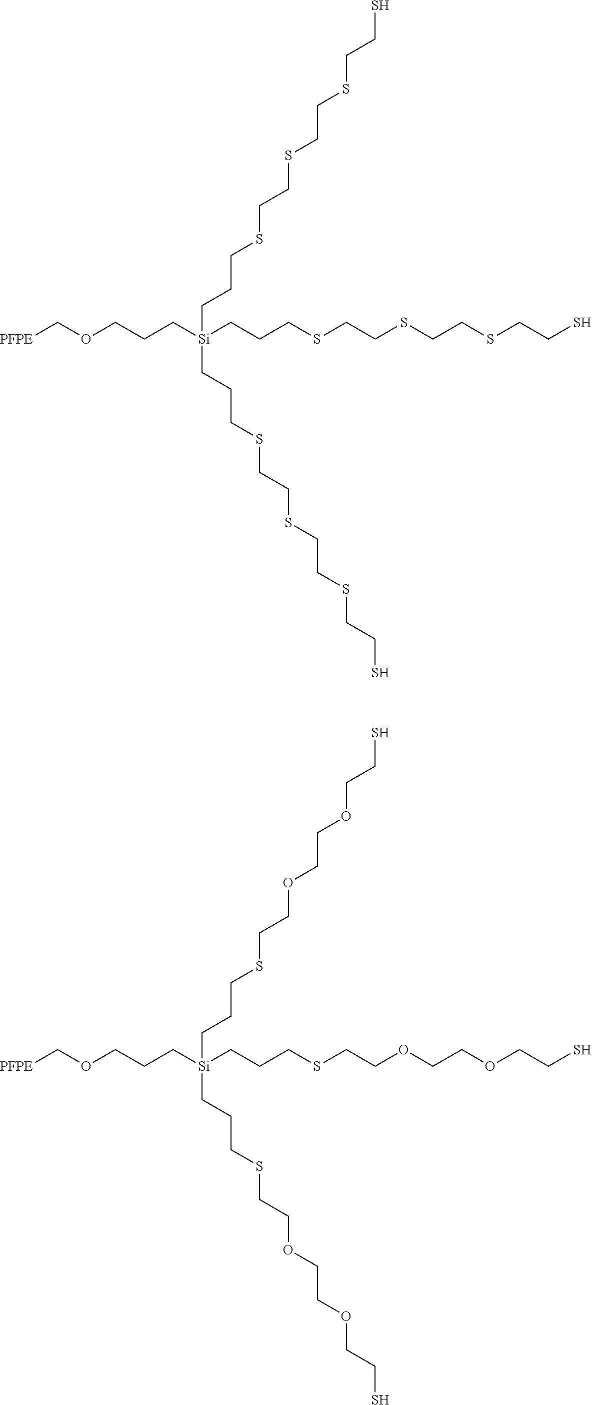

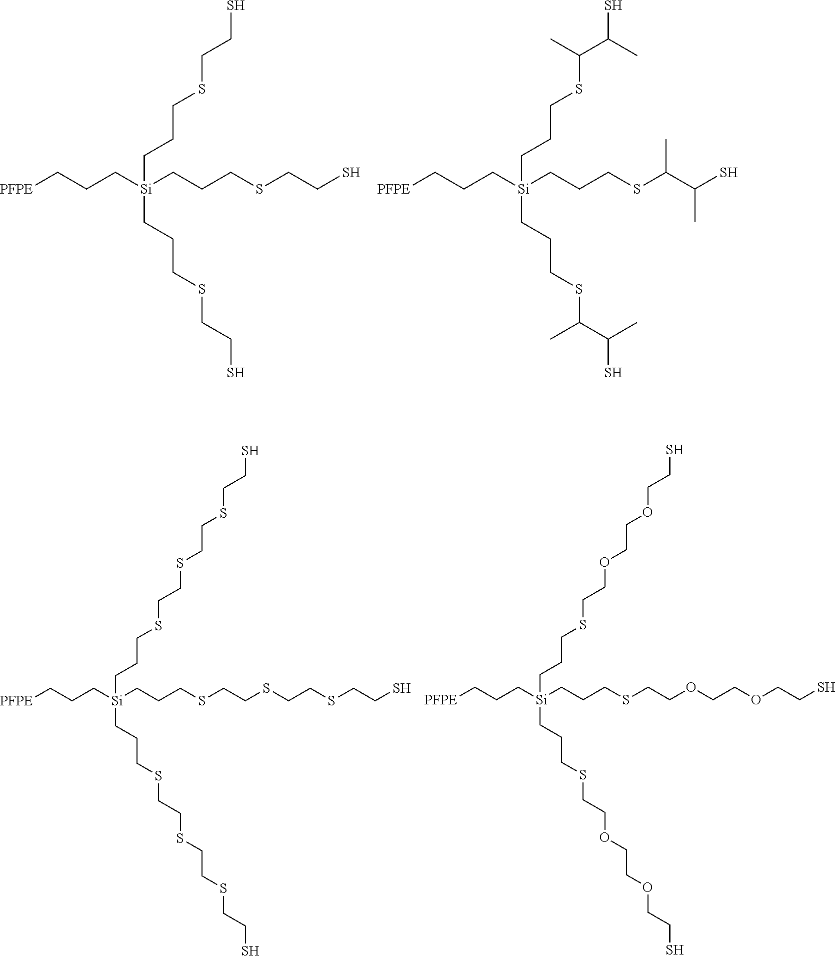

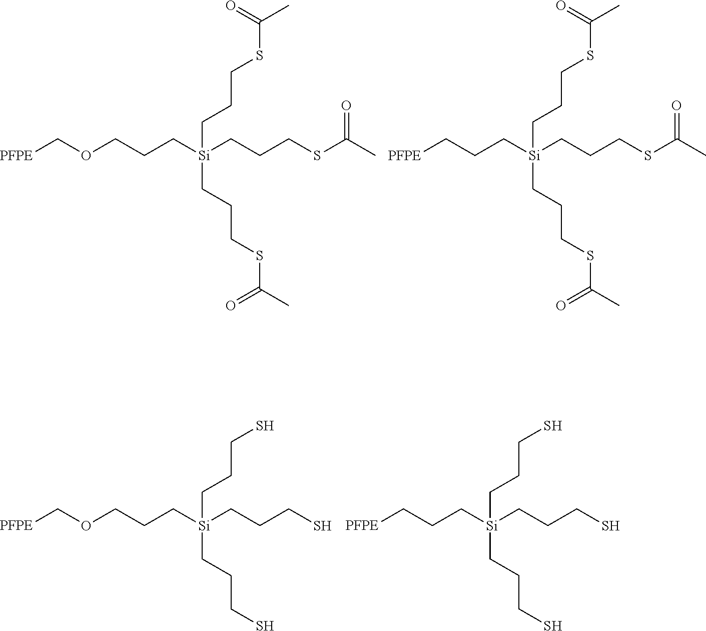

### (Method for Producing Compound (1-1))

As one example of the method for producing a compound (1-1), a production method by a thiol-ene reaction of compound (1a-1) and compound (1b-1), may be mentioned.

[R^{f}—(OXₘ)—O—]ⱼ₁Y¹—Z¹[-L^{a1}-CH═CH₂]_{g11}[R¹²]_{g12} (1a-1)

HS—R¹¹¹ (1b-1)

In the formula (1a-1), the definitions of R^{f}, X, m, j1, Y¹, Z¹, g11, R¹² and g12 are as described above, and L^{a1} is a single bond or a divalent linking group. As specific examples of the divalent linking group in L^{a1}, the divalent linking groups in L¹ of the formula (1-1) may be mentioned.

In the formula (1b-1), R¹¹¹ is a monovalent substituent. As specific examples of the monovalent substituent in R¹¹¹, the monovalent substituents in R¹¹ in the formula (1-1) may be mentioned.

By the reaction of compound (1a-1) and compound (1b-1), it is possible to obtain a compound (1-1) wherein L¹ has the structure derived from L^{a1}-CH═CH₂ of the compound (1a-1) and R¹¹ is R¹¹¹.

Specific examples of the compound (1b-1) are as follows.

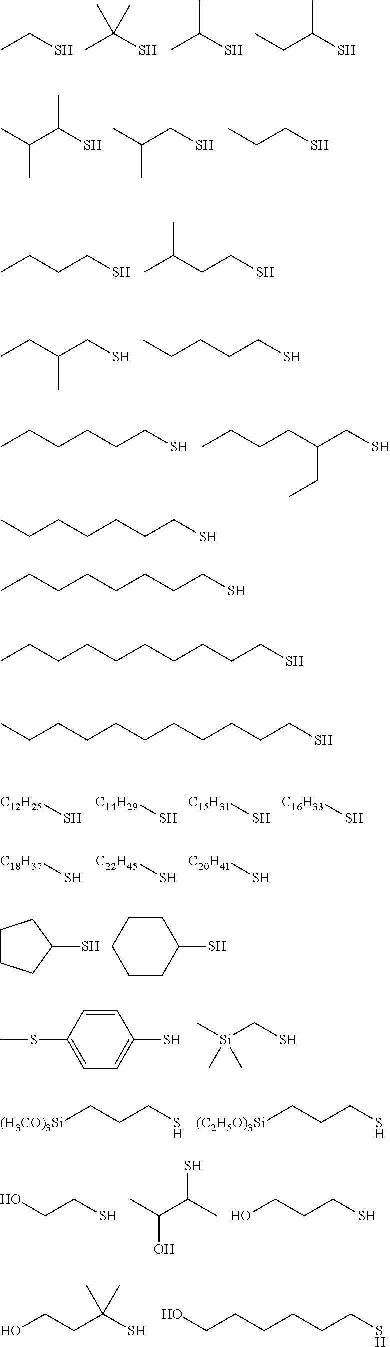

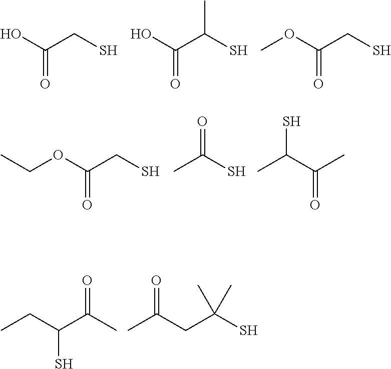

As another production method for the compound (1-1), a method of reacting the above-described compound (1a-1) and compound (1b-2), may be mentioned.

HS-L^{a2}-SH (1b-2)

In the formula (1b-2), the definition of R¹¹ is as described above, and L^{a2} is a divalent linking group. As specific examples of the divalent linking group in L^{a2}, the divalent linking groups in the above-described L¹ may be mentioned.

By the reaction of the compound (1a-1) and the compound (1b-2), it is possible to obtain a compound (1-1) wherein L¹ has a structure derived from L^{a1}-CH═CH₂ of the compound (1a-1) and L^{a2}-SH of the compound (1b-2), and R¹¹ is a hydrogen atom.

Specific examples of the compound (1b-2) are as follows.

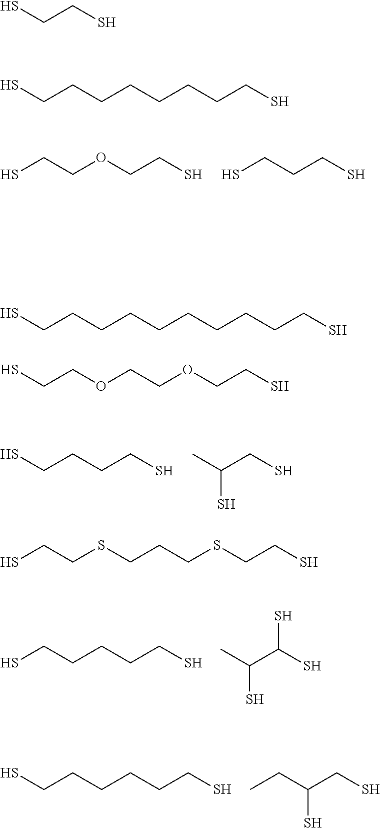

### Second Embodiment

The fluorinated ether compound of the second embodiment of the present invention is a compound represented by the formula (1-2) as described below (compound (1-2)), which has a thiol structure or a thioether structure.

The present inventors have found that when a water and oil repellent layer is formed by using the compound (1-2), on a substrate containing gold, silver or copper, the water and oil repellent layer is excellent in abrasion resistance. The details of the reason for this have not been clarified, but it is assumed to be due to the same reason as when the fluorinated ether compound of the first embodiment is used.

The compound (1-2) is a fluorinated ether compound represented by the formula (1-2).

[R²¹]_{g21}[R²²—S-L²¹]_{g22}Z²¹—Y²¹—(OX)ₘ—O—Y²²—Z²²[-L²²-S—R²³]_{g23}[R²⁴]_{g24} (1-2)

In the formula (1-2), R²¹ and R²⁴ are each independently a monovalent substituent. Specific examples and preferred embodiments of the monovalent substituent in R²¹ and R²⁴ are the same as the monovalent substituent in R¹² in the formula (1-1).

R²² and R²³ are each independently a hydrogen atom or a monovalent substituent. Specific examples and preferred embodiments of the monovalent substituent in R²² and R²³ are the same as the monovalent substituent in R¹¹ in the formula (1-1).

L²¹ and L²² are each independently a single bond or a divalent linking group. Specific examples and preferred embodiments of the divalent linking group in L²¹ and L²² are the same as the divalent linking group in L¹ in the formula (1-1).

Z²¹ is a (g21+g22+1) valent linking group. Specific examples and preferred embodiment of the (g21+g22+1) valent linking group are the same as the (g11+g12+1) valent linking group in Z¹ in the formula (1-1).

Z²² is a (g23+g24+1) valent linking group. Specific examples and preferred embodiments of the (g23+g24+1) valent linking group are the same as the (g11+g12+1) valent linking group in Z¹ in the formula (1-1).

Y²¹ and Y²² are each independently a single bond or a divalent linking group. Specific examples and preferred embodiments of the divalent linking group are the same as the (j1+1) valent linking group in Y¹ in the formula (1-1). However, when Y²¹ and Y²² are divalent linking groups, the divalent linking groups do not contain two or more ester bonds.

X is a fluoroalkylene group having at least one fluorine atom, and its specific examples and preferred embodiments are the same as X in the formula (1-1).

m is an integer of at least 2, and its specific examples and preferred embodiments are the same as m in the formula (1-1).

(OX)ₘ is a poly(oxyfluoroalkylene) chain, and its specific examples and preferred embodiments are the same as (OX)ₘ in the formula (1-1).

g21 and g24 are each independently an integer of at least 0, preferably from 0 to 3, more preferably from 0 to 1, and, from such a viewpoint that the abrasion resistance of the water and oil repellent layer will be superior, 0 is particularly preferred.

g22 and g23 are each independently an integer of at least 2, and, from such a viewpoint that the abrasion resistance of the water and oil repellent layer will be superior, at least 3 is preferred. g22 and g23 are each independently at most 15, more preferably at most 8, particularly preferably at most 6.

The plurality of [R²²—S-L²¹-] which the compound (1-2) has, may be different.

The plurality of [-L²²-S—R²³] which the compound (1-2) has, may be different.

In a case where the compound (1-2) has a plurality of R²¹, the plurality of R²¹ may be different.

In a case where the compound (1-2) has a plurality of R²⁴, the plurality of R²⁴ may be different.

The portion represented by Z²¹—Y²¹ and the portion represented by Y²²—Z²² in the formula (1-2) are preferably each independently a group represented by the following formula (g2-1) to formula (g2-8).

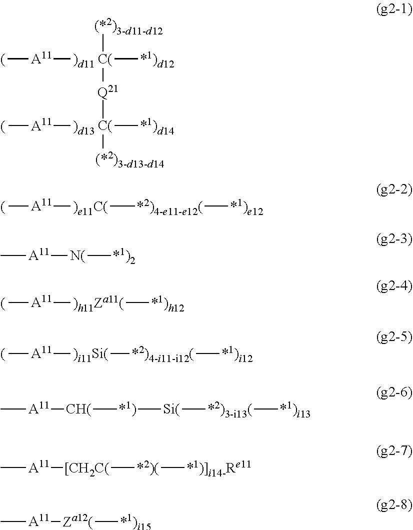

Here, in the above formula (g2-1) to formula (g2-8), the symbol corresponding to g22 and the symbol corresponding to g23 in the formula (2) and their definitions are as follows.

Formula (g2-1): g22=d12+d14, g23=d12+d14, d11+d13=1

Formula (g2-2): g22=e12, g23=e12, e11=1

Formula (g2-3): g22=2, g23=2

Formula (g2-4): g22=h12, g23=h12, h11=1

Formula (g2-5): g22=i12, g23=i12, i11=1

Formula (g2-6): g22=i13+1, g23=i13+1

Formula (g2-7): g22=i14, g23=i14

Formula (g2-8): g22=i15, g23=i15

In the formula (g2-1) to formula (g2-8), A¹¹ corresponds to Y²¹ or Y²² in the formula (1-2).

In the formula (g2-1) to formula (g2-8), *¹ means the bonding position to [R²²—S-L²¹-] or [-L²²-S—R²³] in the formula (1-2), and *² means the bonding position to R²¹ or R²⁴ in the formula (1-2).

The definition and preferred embodiments of A¹¹ are the same as A¹ in the formula (g1-1) to formula (g1-8). However, A¹¹ does not contain two or more ester bonds.

The definitions and preferred embodiments of Q²¹, Z^{a11}, Z^{a12} and R^{e11} are respectively the same as Q¹¹, Z^{a11}, Z^{a12} and R^{e11} in the formula (g1-1) to formula (g1-8).

d11 is 0 or 1. d12 is an integer of from 0 to 3. d11+d12 is an integer of from 1 to 3.

d13 is 0 or 1. d14 is an integer of form 0 to 3. d13+d14 is an integer of from 1 to 3.

d11+d13 is 1.

d12+d14 is an integer of from 2 to 5, preferably 4 or 5.

e11+e12 is 3 or 4. e11 is 1. e12 is 2 or 3.

h11 is 1. h12 is an integer of at least 2, preferably from 2 to 6, more preferably from 2 to 4, particularly preferably 2 or 3.

i11+i12 is 3 or 4. i11 is at least 1. i12 is an integer of at least 2, preferably 2 or 3.

i13 is an integer of from 1 to 3, preferably 2 or 3.

i14 is an integer of at least 2, preferably an integer of from 2 to 10, particularly preferably an integer of from 2 to 6.

i15 is an integer of from 2 to 7.

Specific examples of the compound (1-2) are shown below. PFPE in the compounds of the following formulas represents —X—(OX)ₘ—O—X—. The definitions of X and m are as described above.

As the compound (1-2) in which the portion represented by Z²¹-Y²¹ and the portion represented by Y²²-Z²² are the groups (g2-2), for example, compounds of the following formulas may be mentioned.

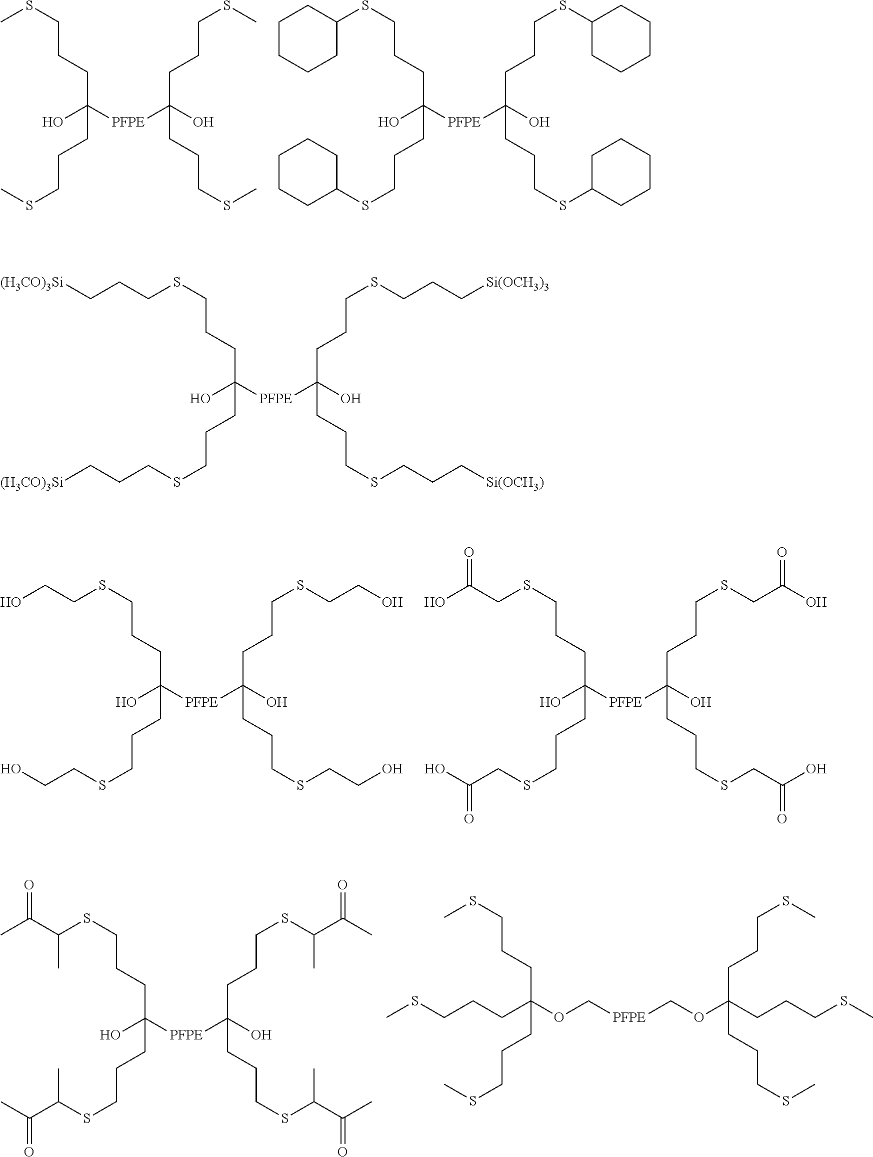

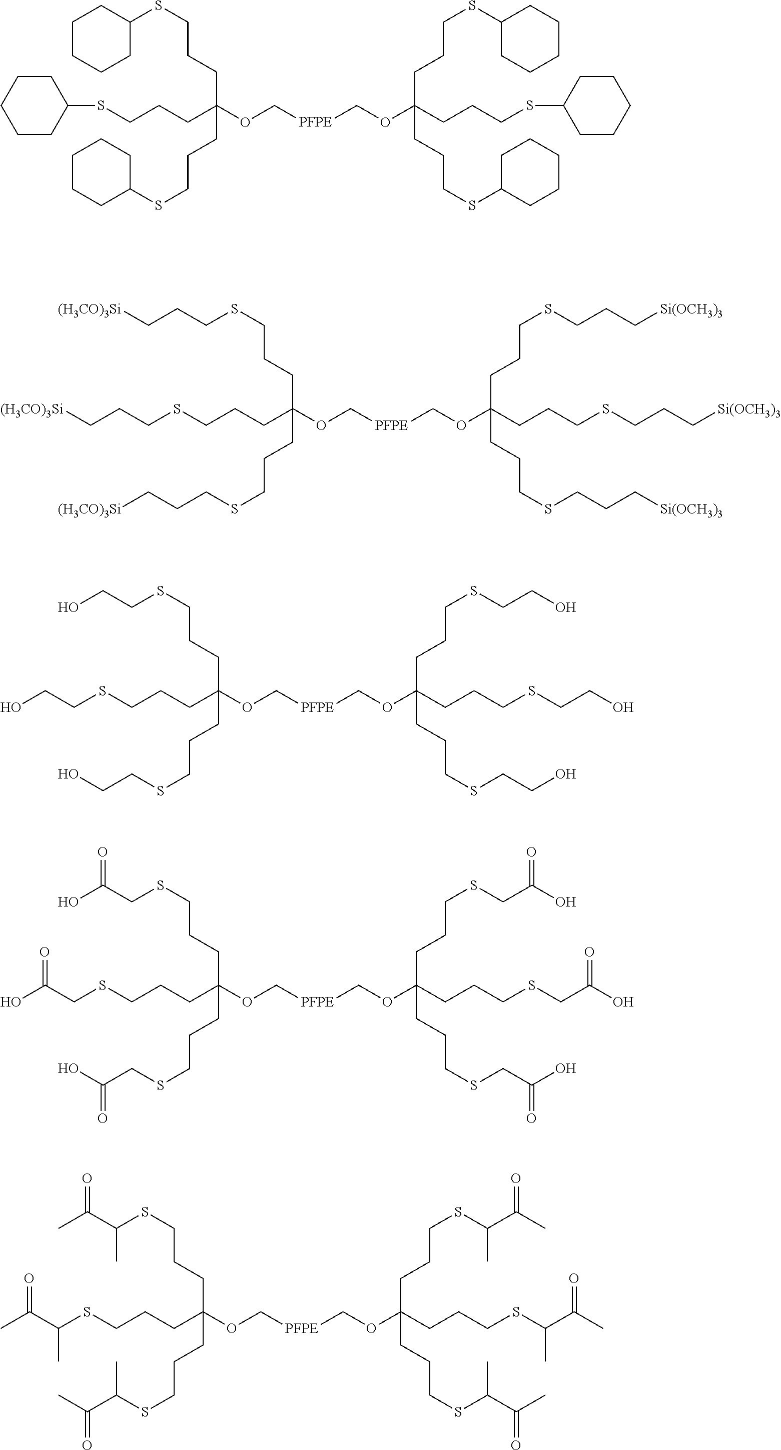

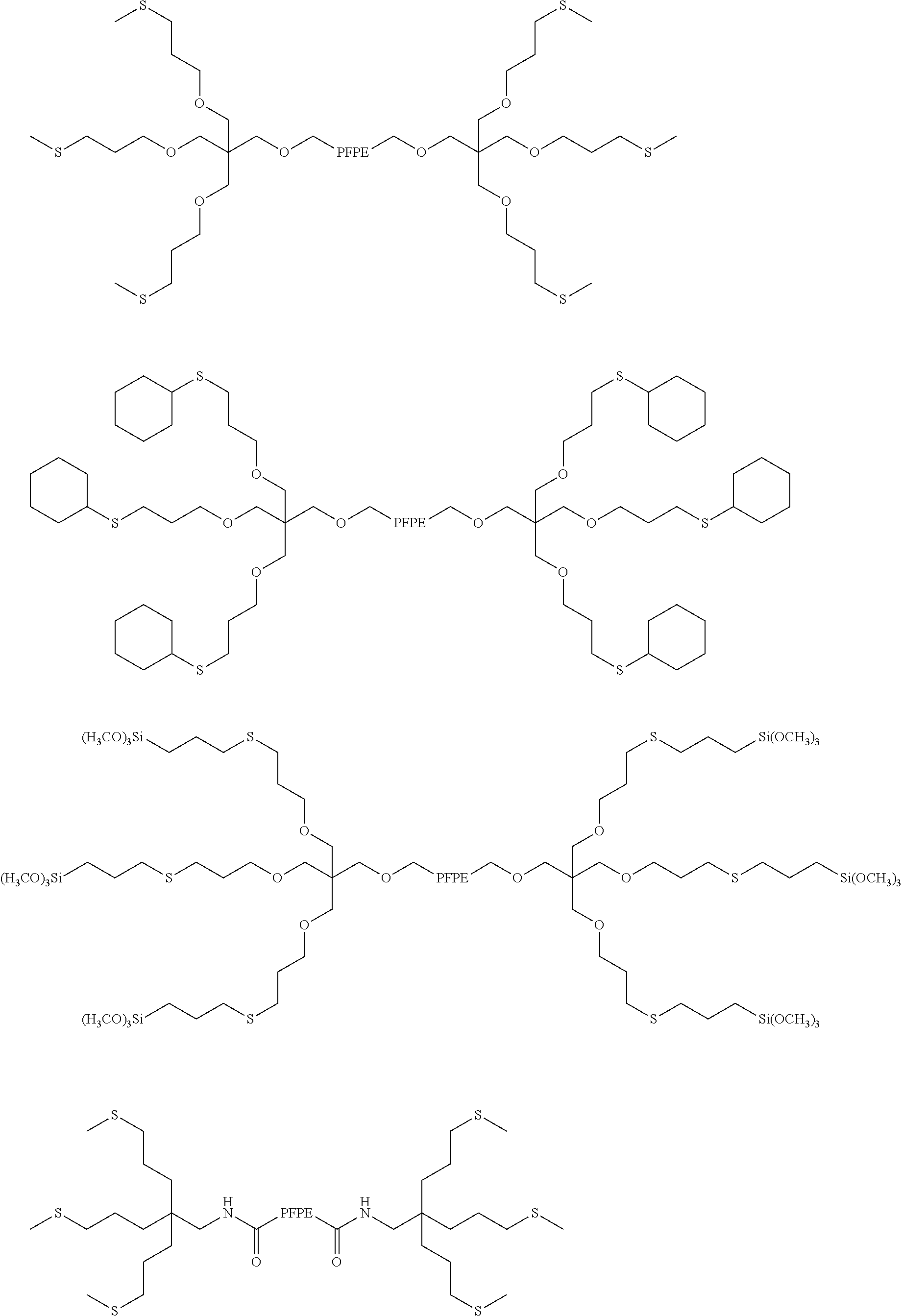

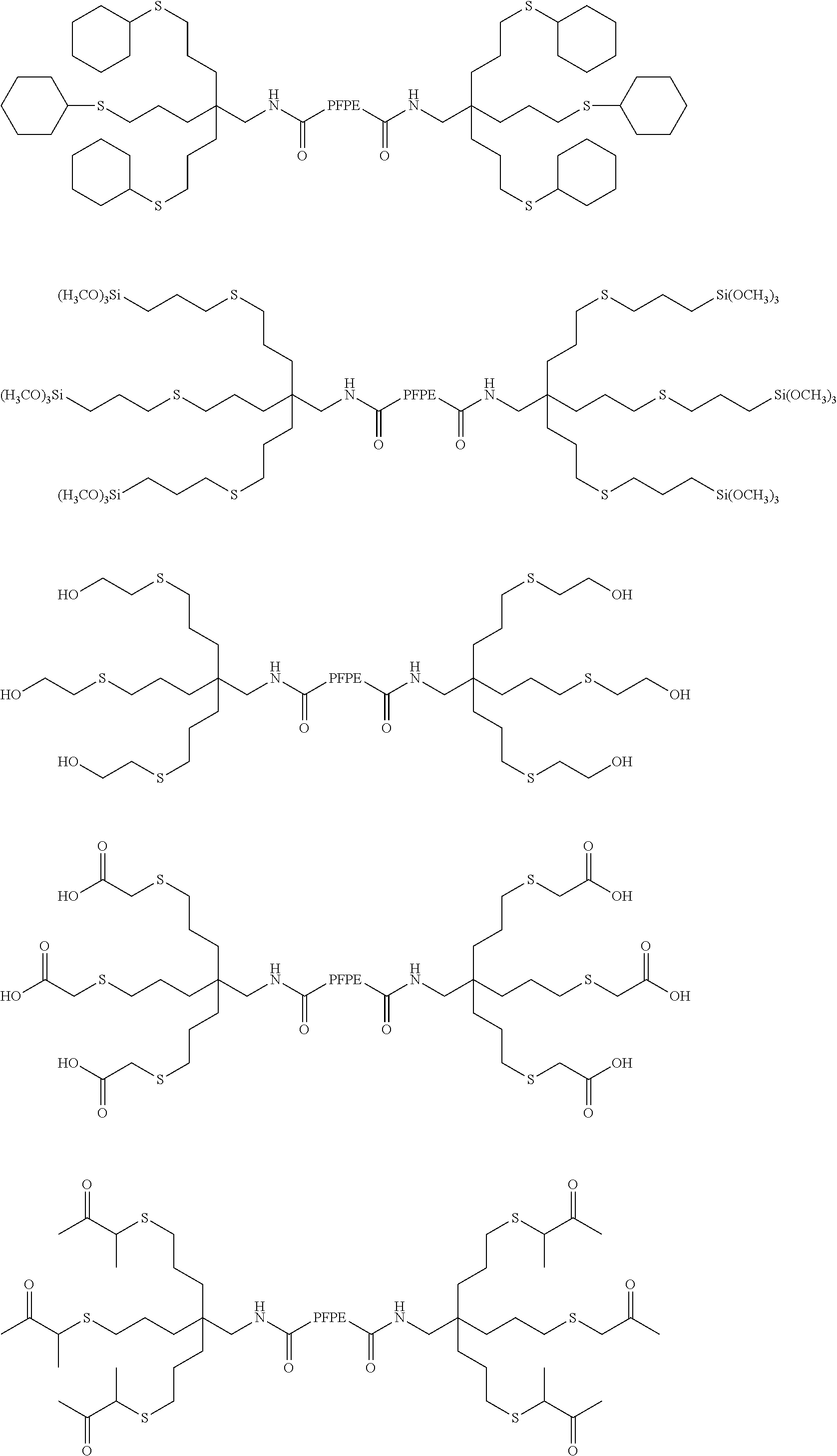

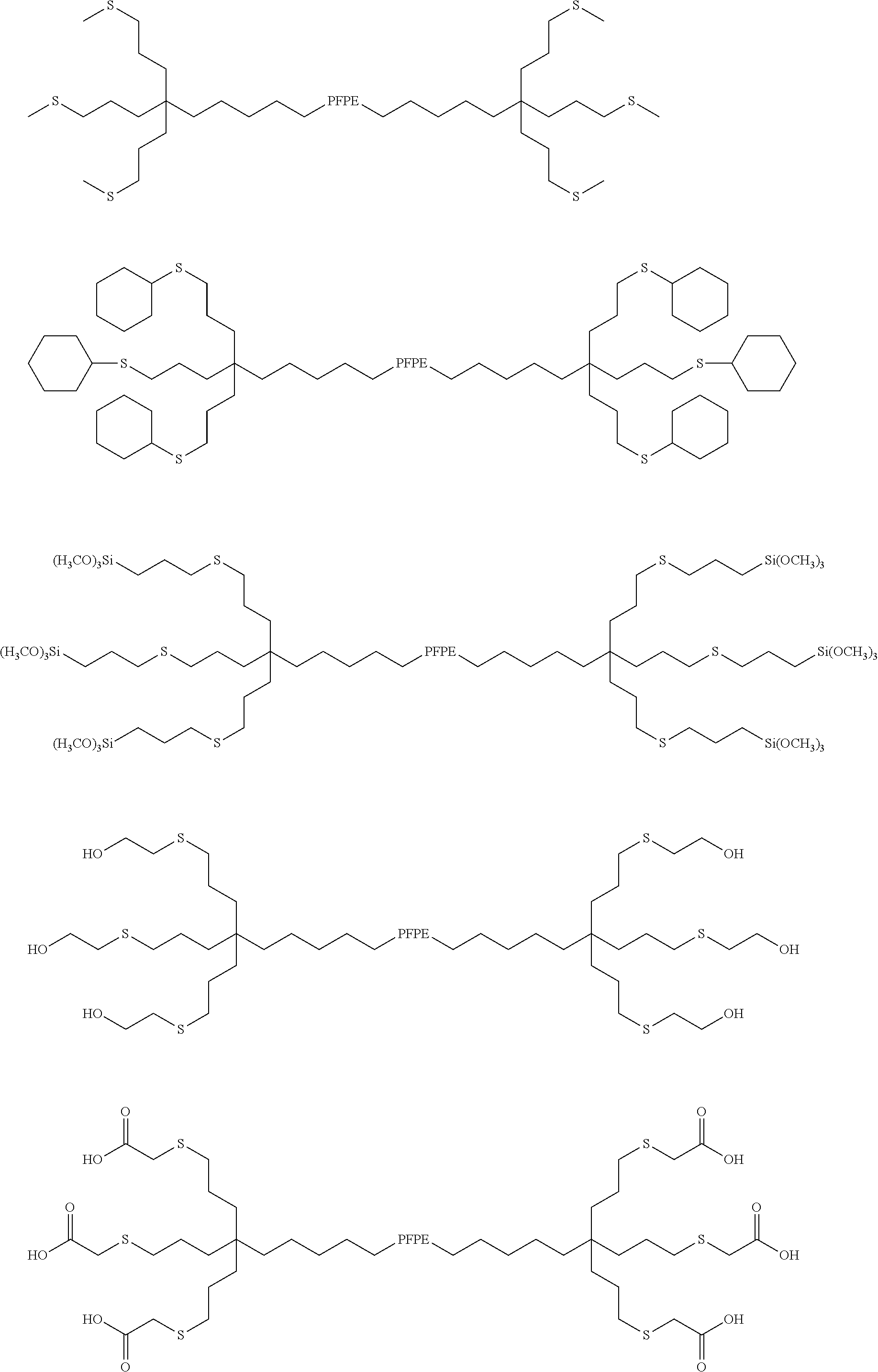

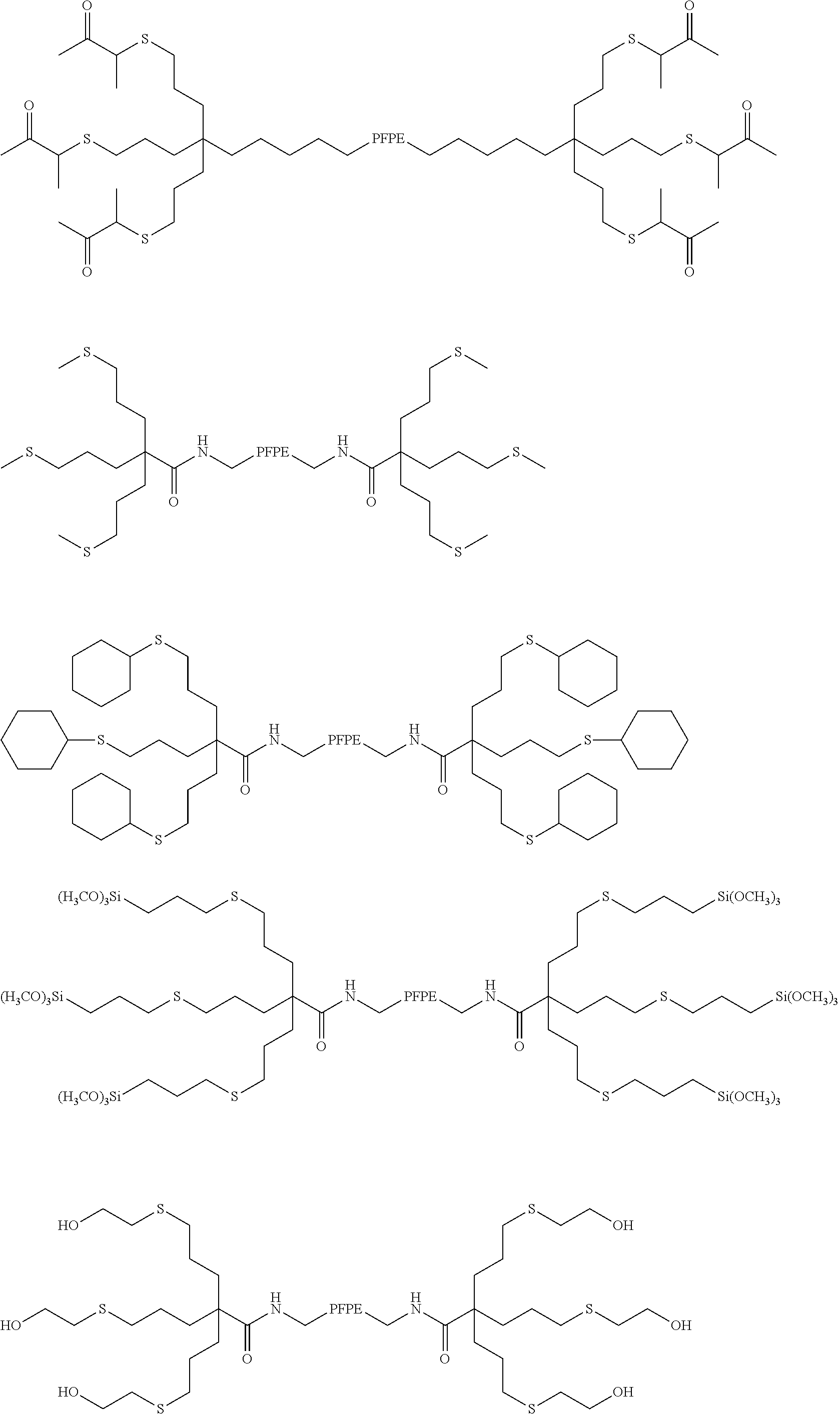

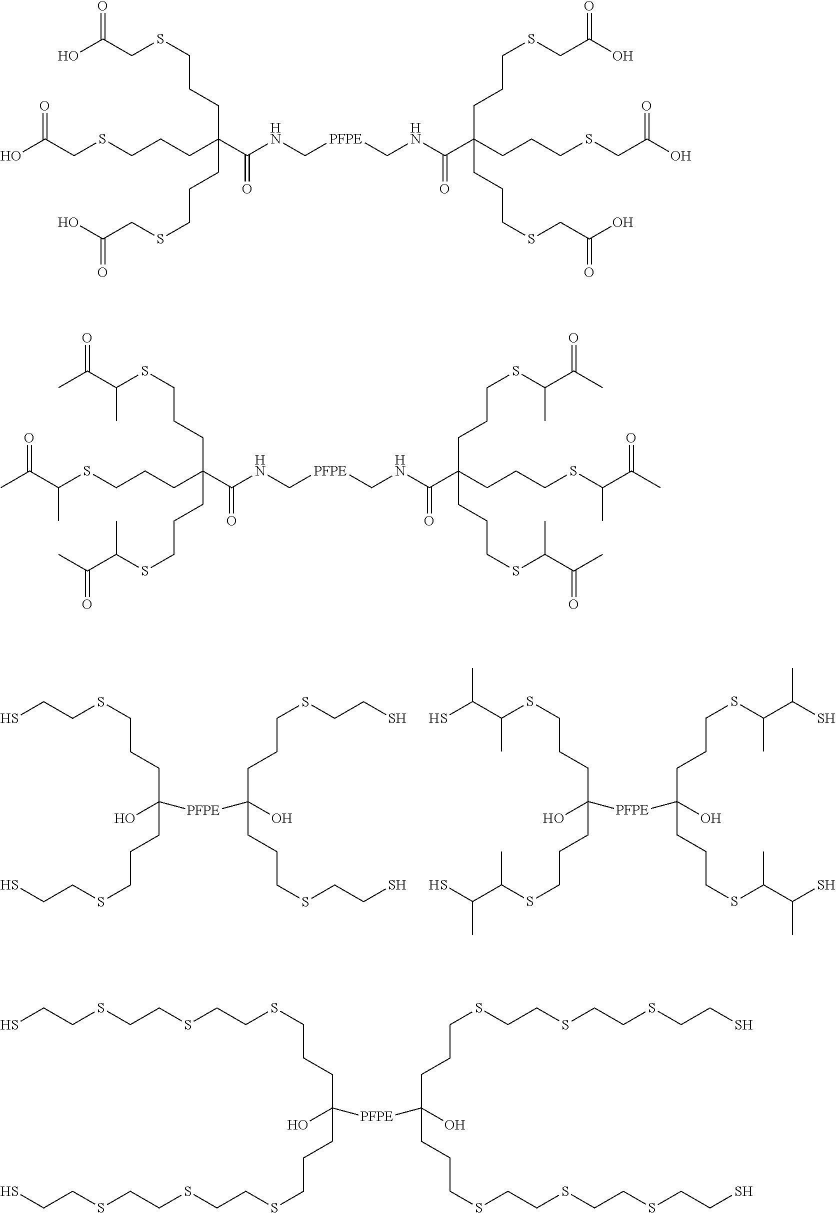

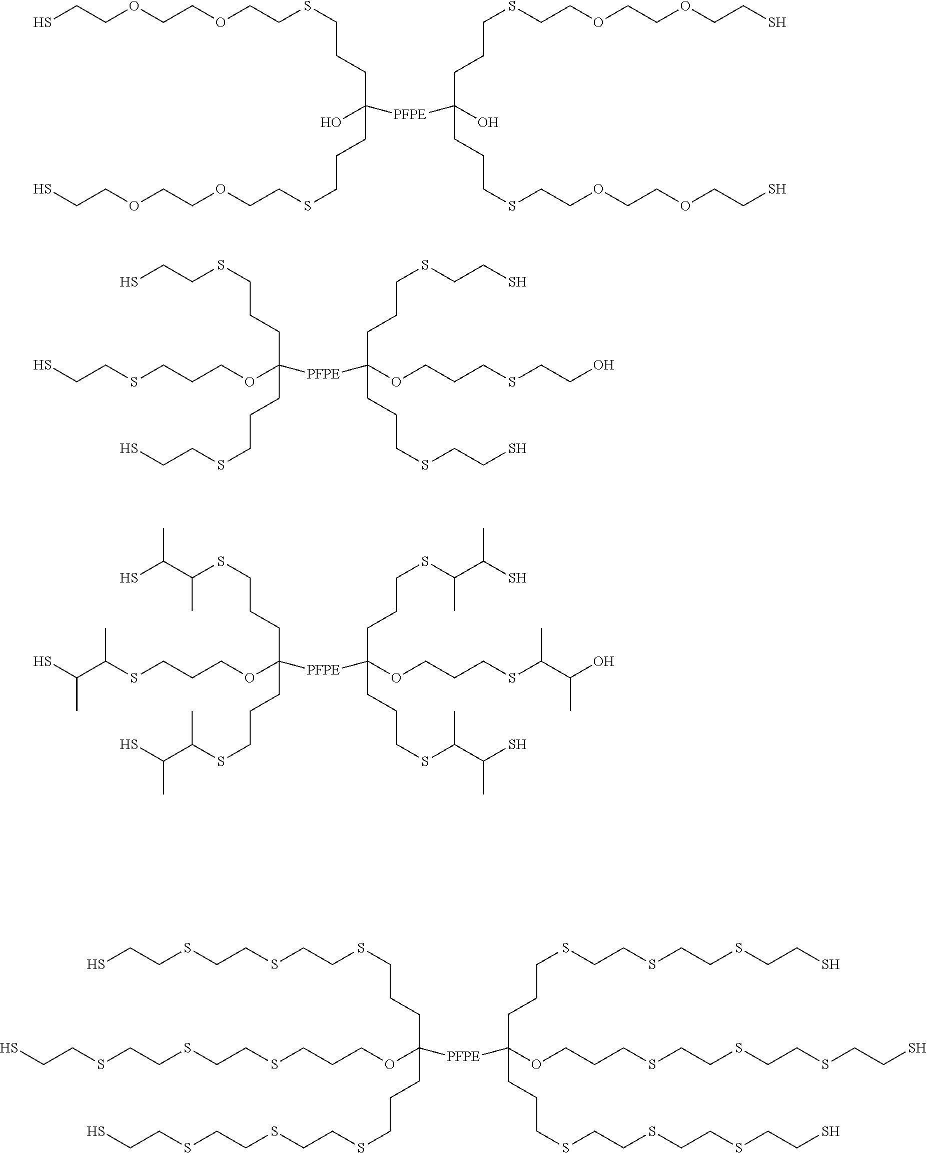

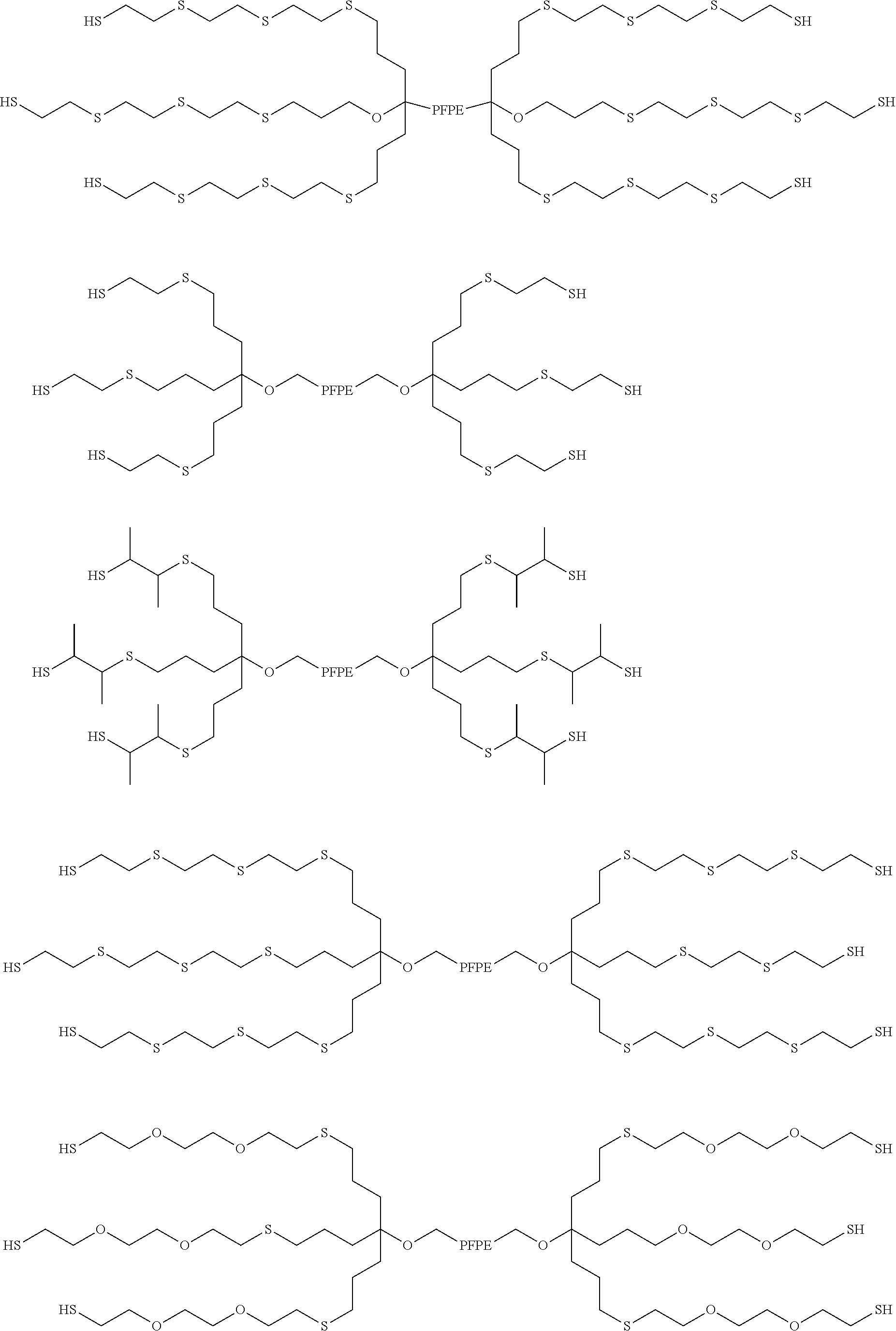

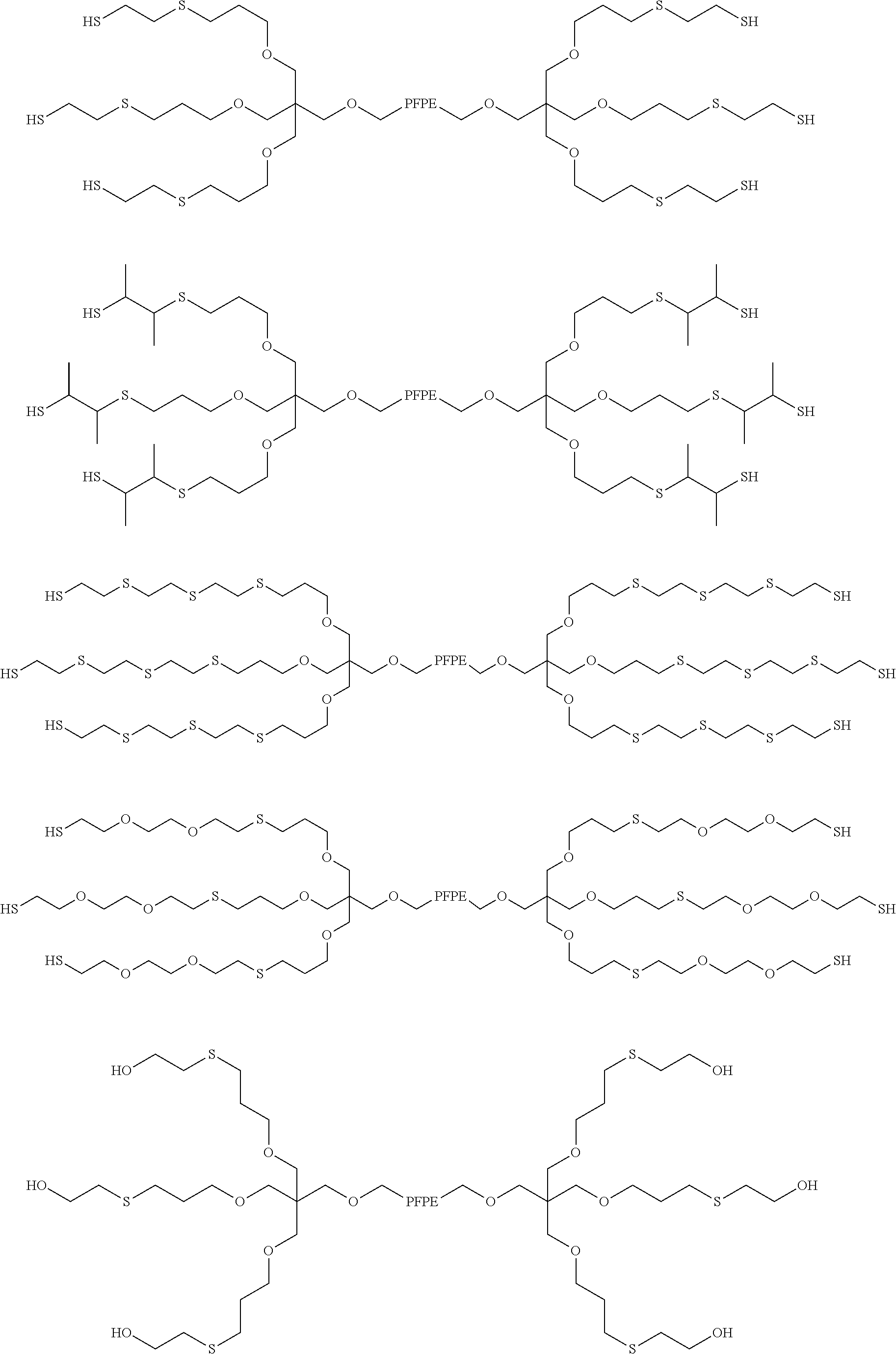

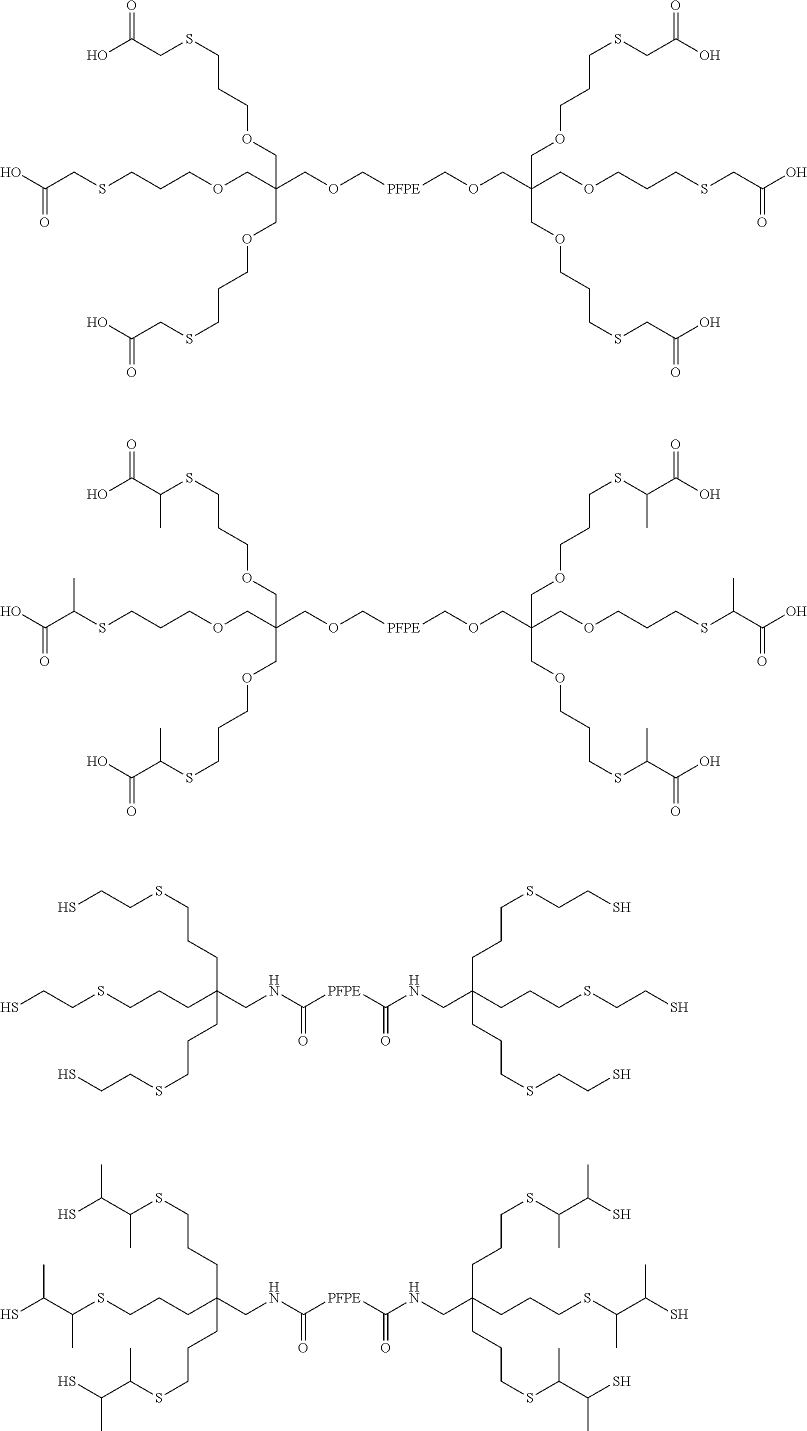

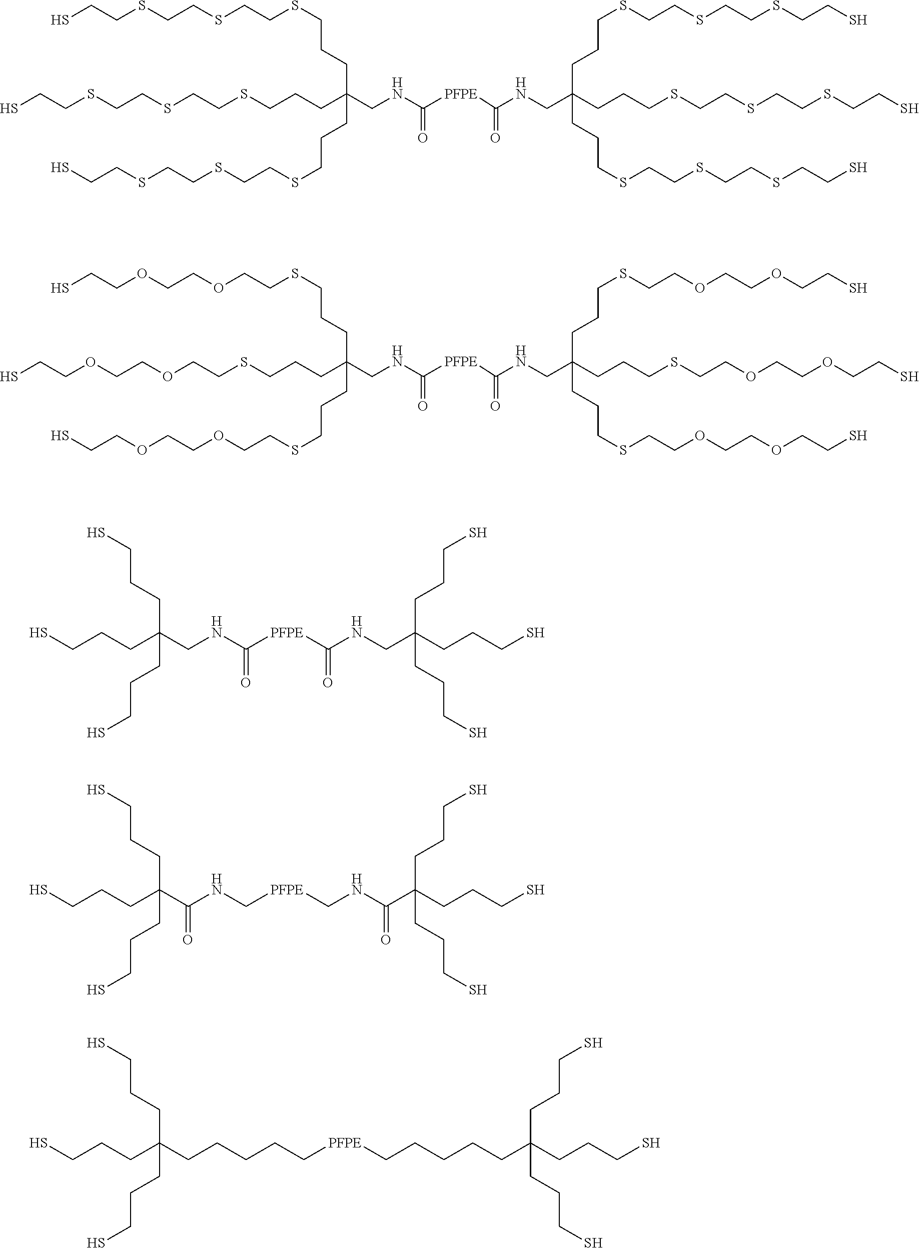

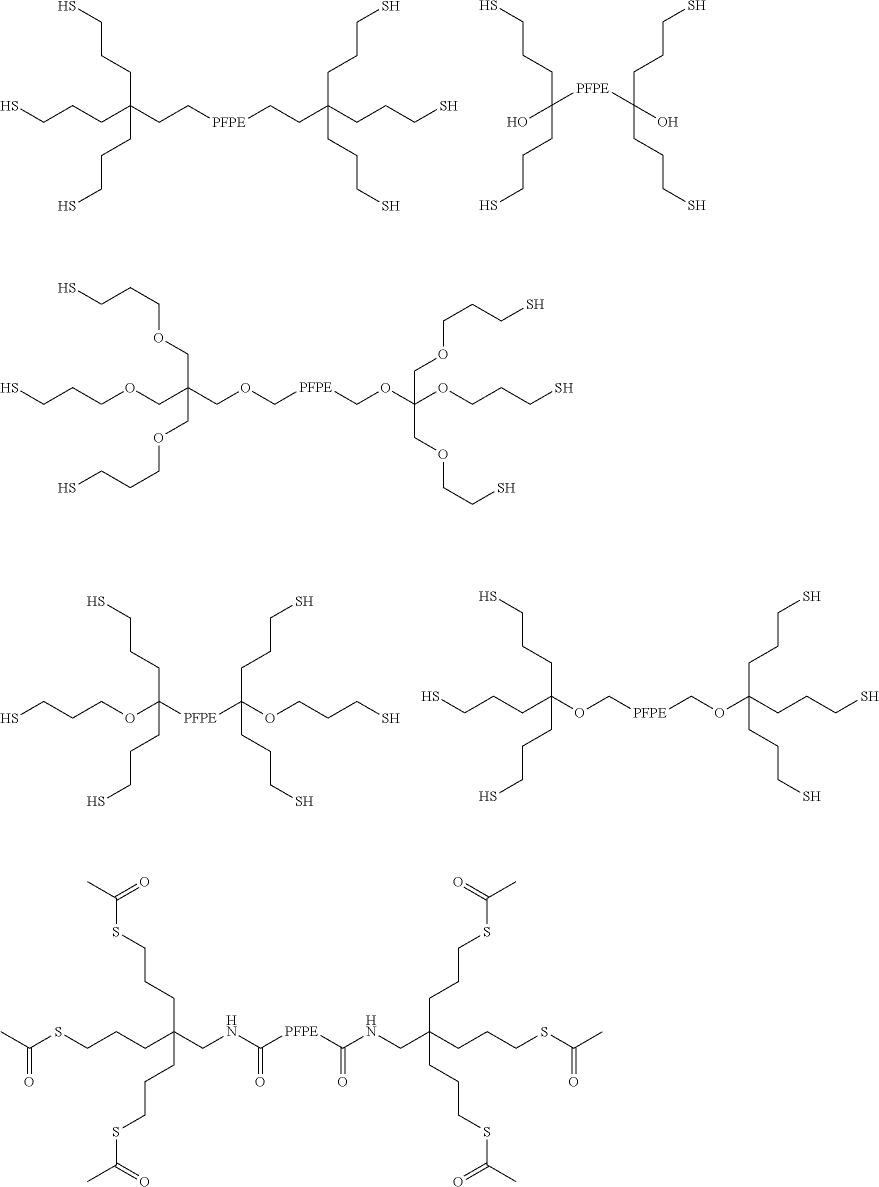

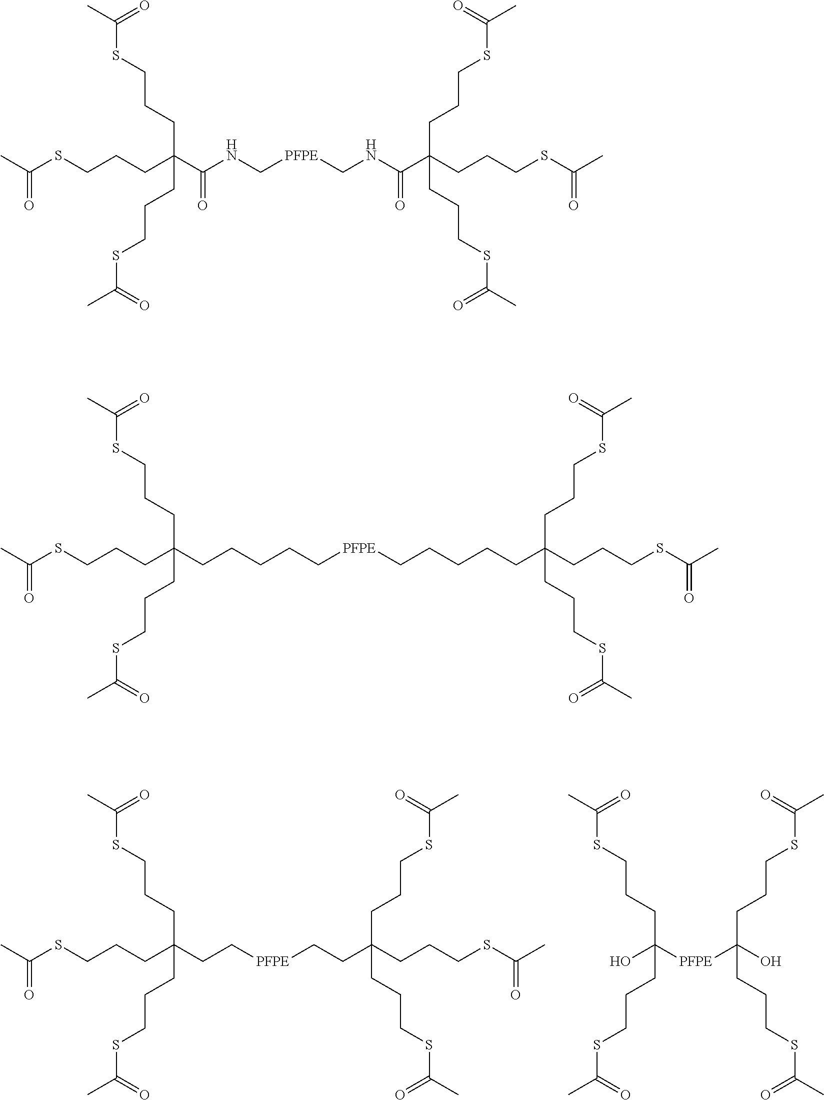

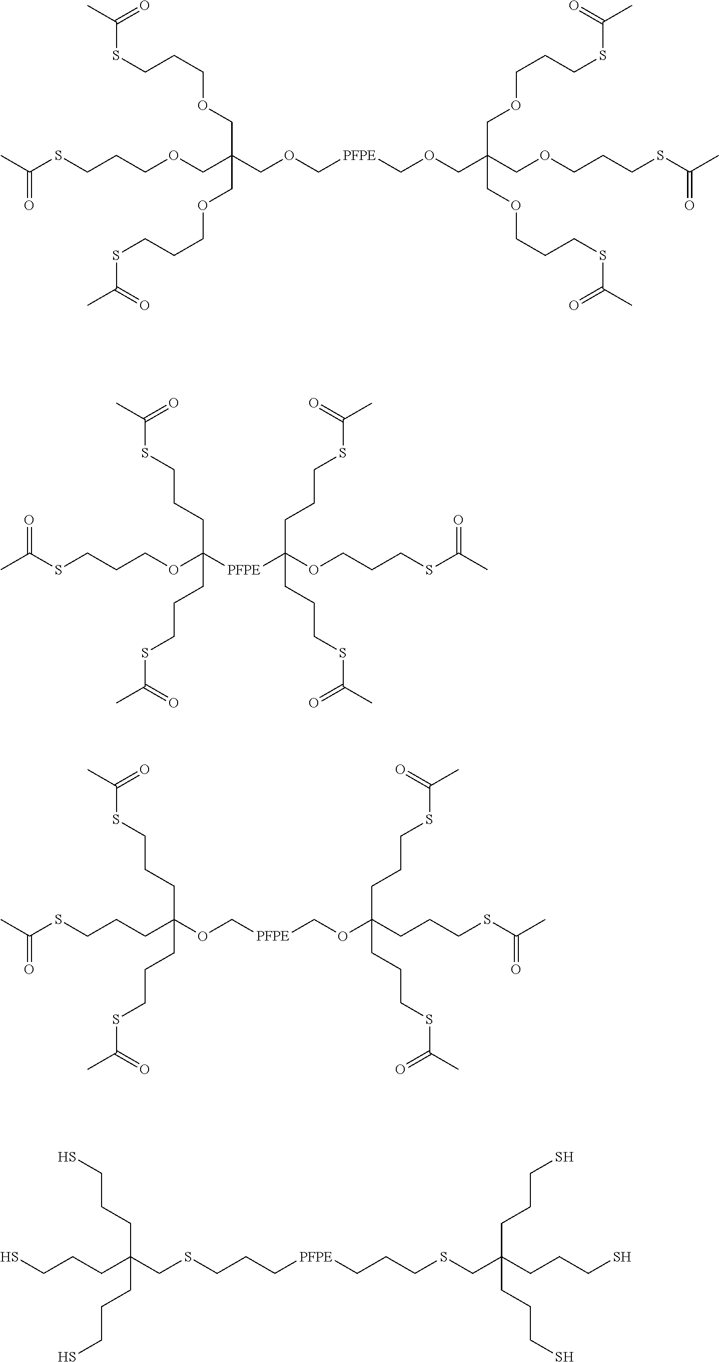

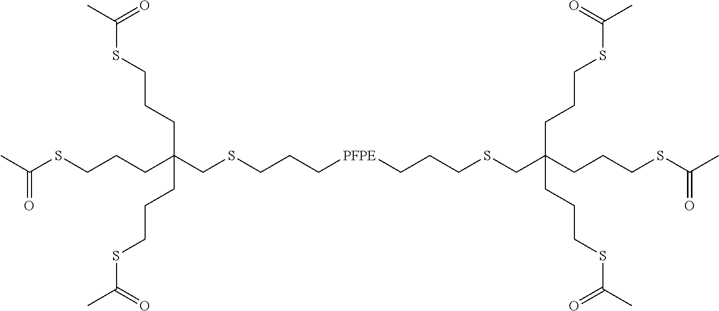

As the compound (1-2) in which the portion represented by Z²¹-Y²¹ and the portion represented by Y²²-Z²² are the groups (g2-4), for example, compounds of the following formulas may be mentioned.

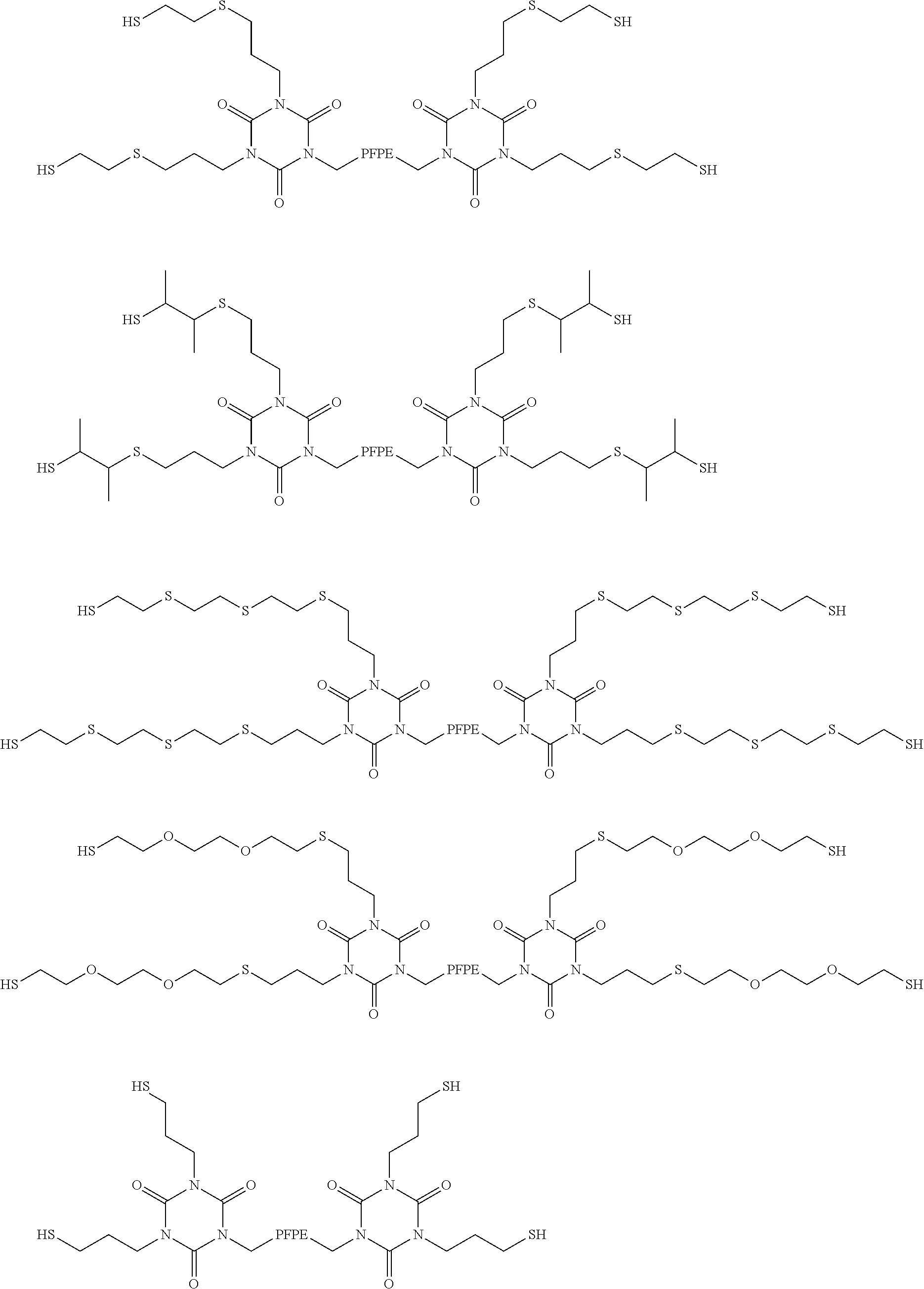

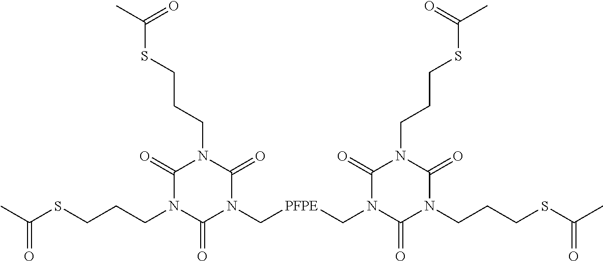

As the compound (1-2) in which the portion represented by Z²¹-Y²¹ and the portion represented by Y²²-Z²² are groups (g2-5), for example, compounds of the following formulas may be mentioned.

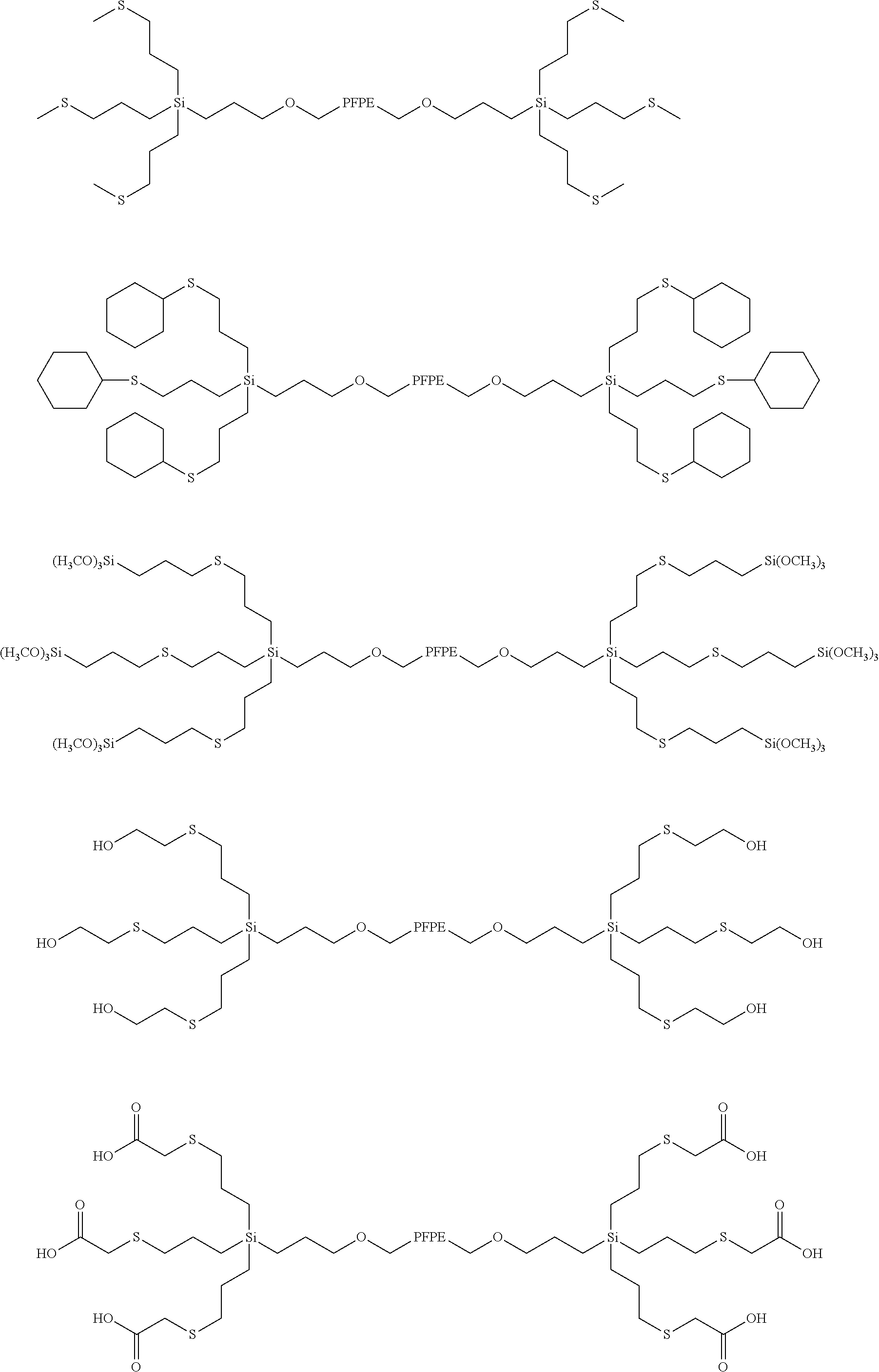

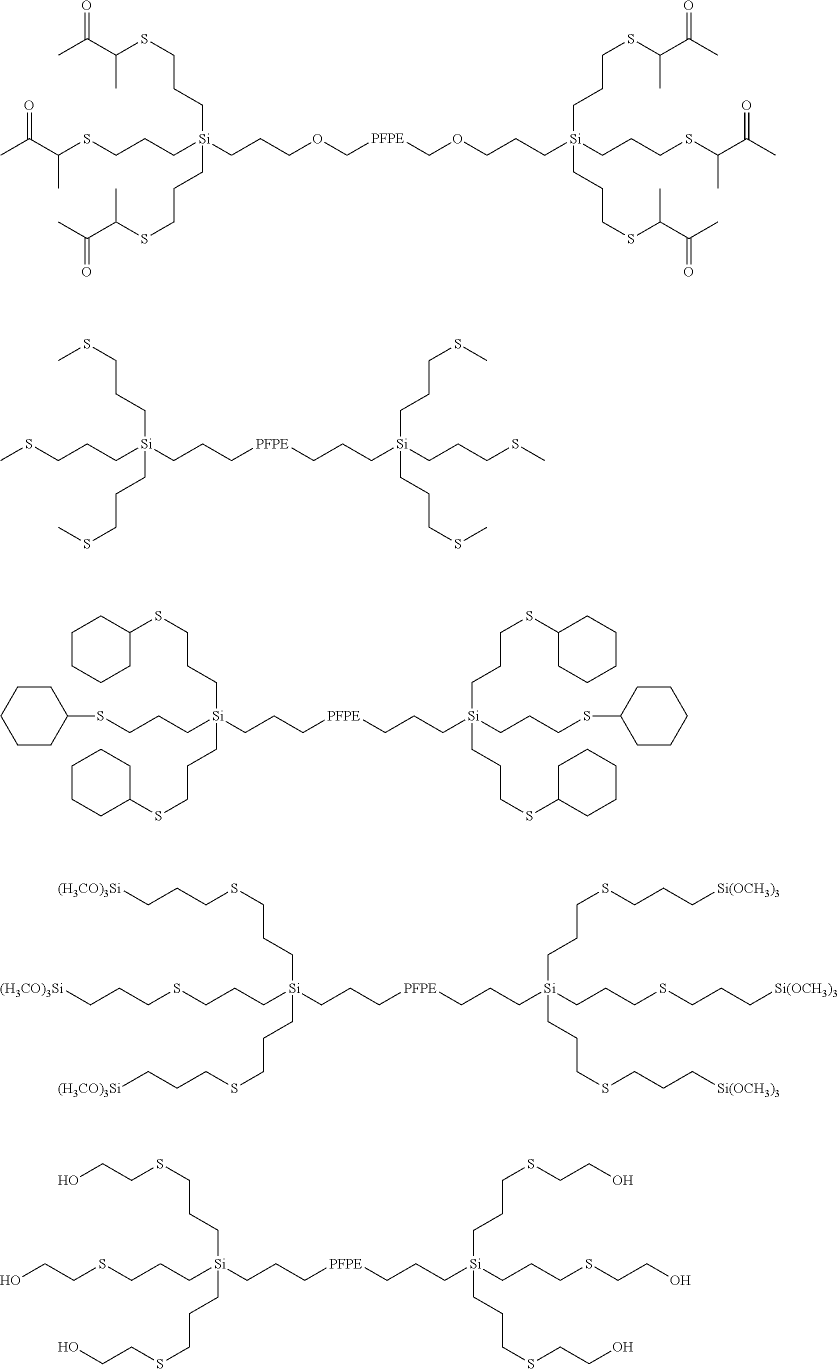

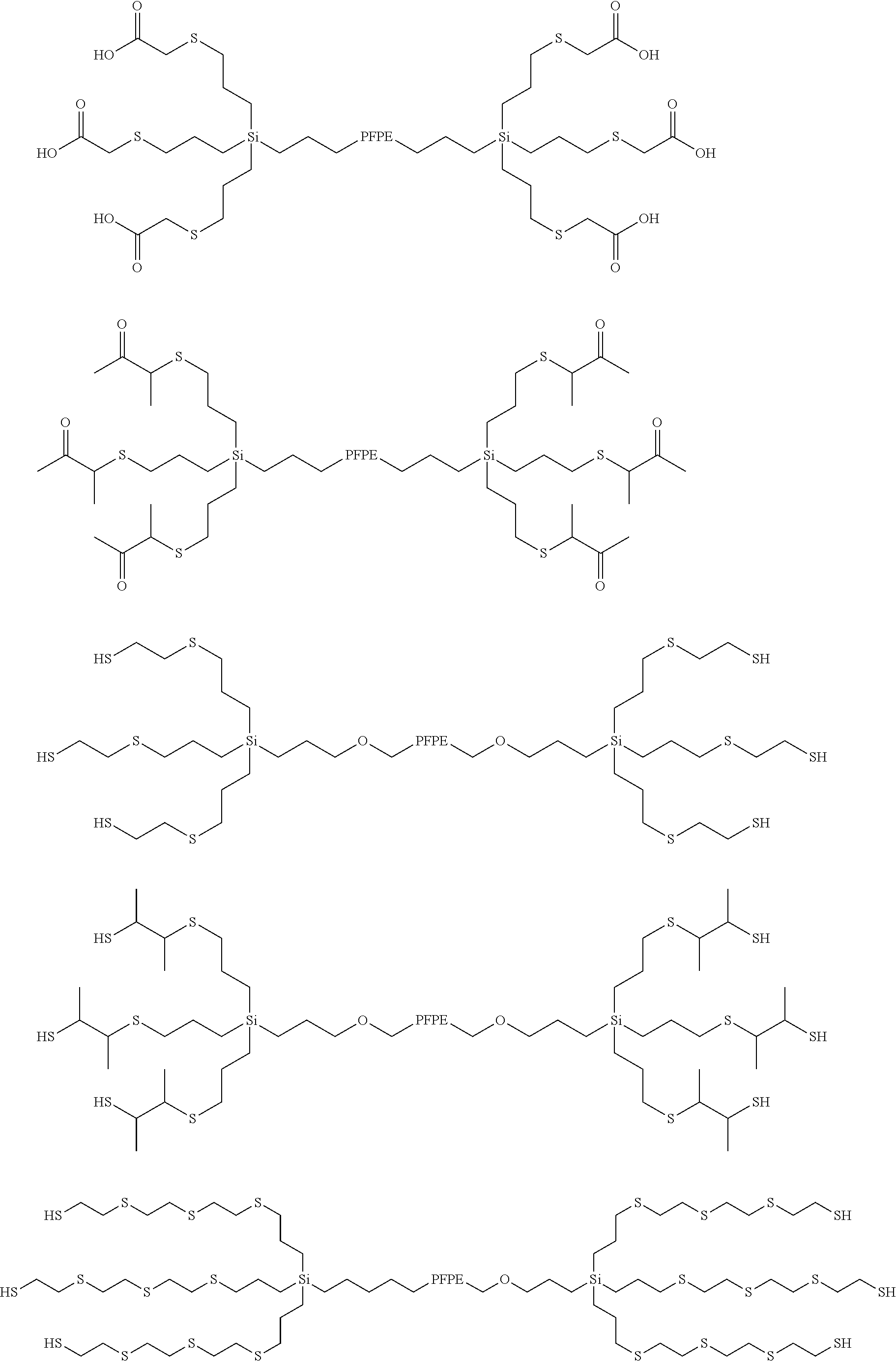

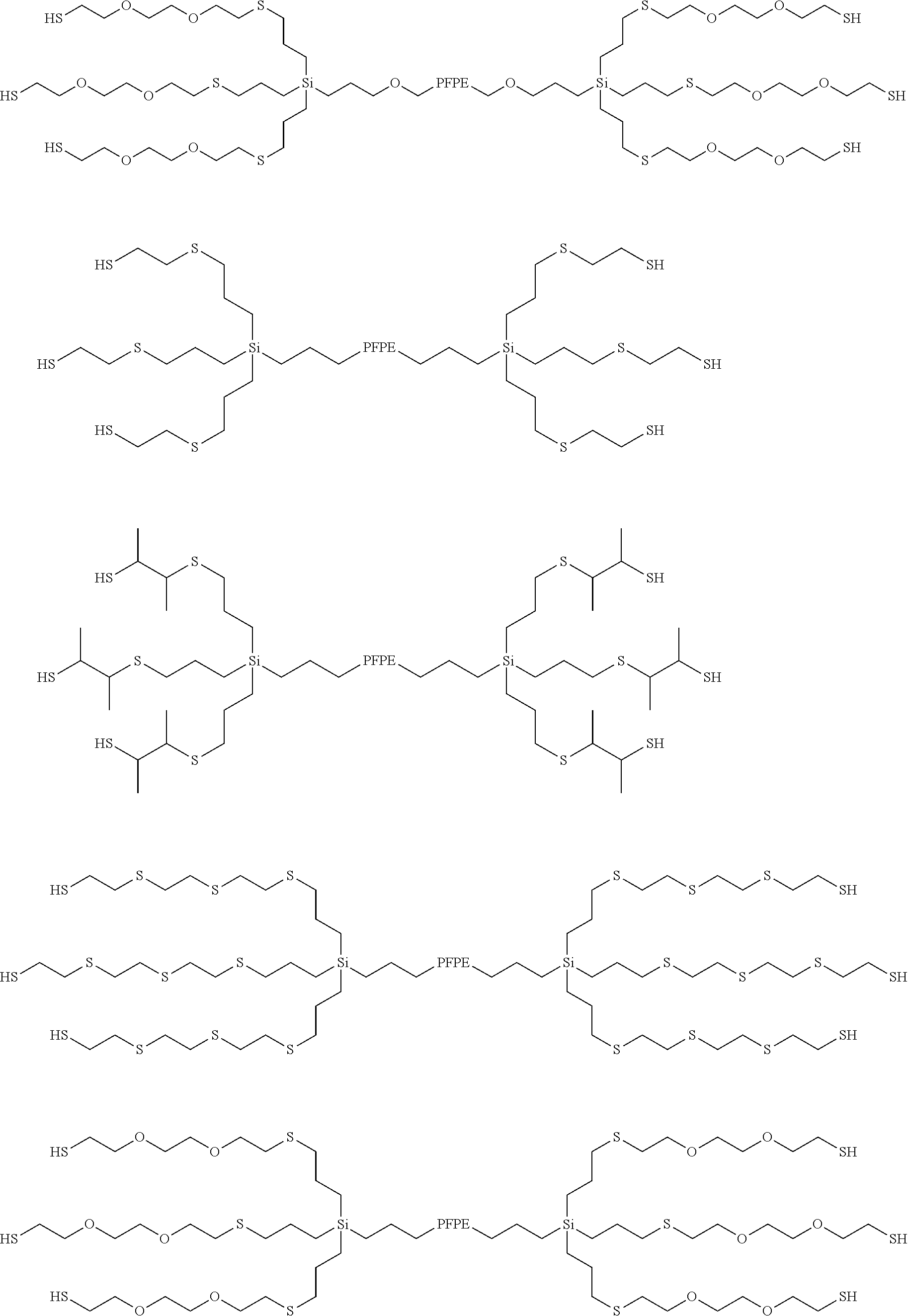

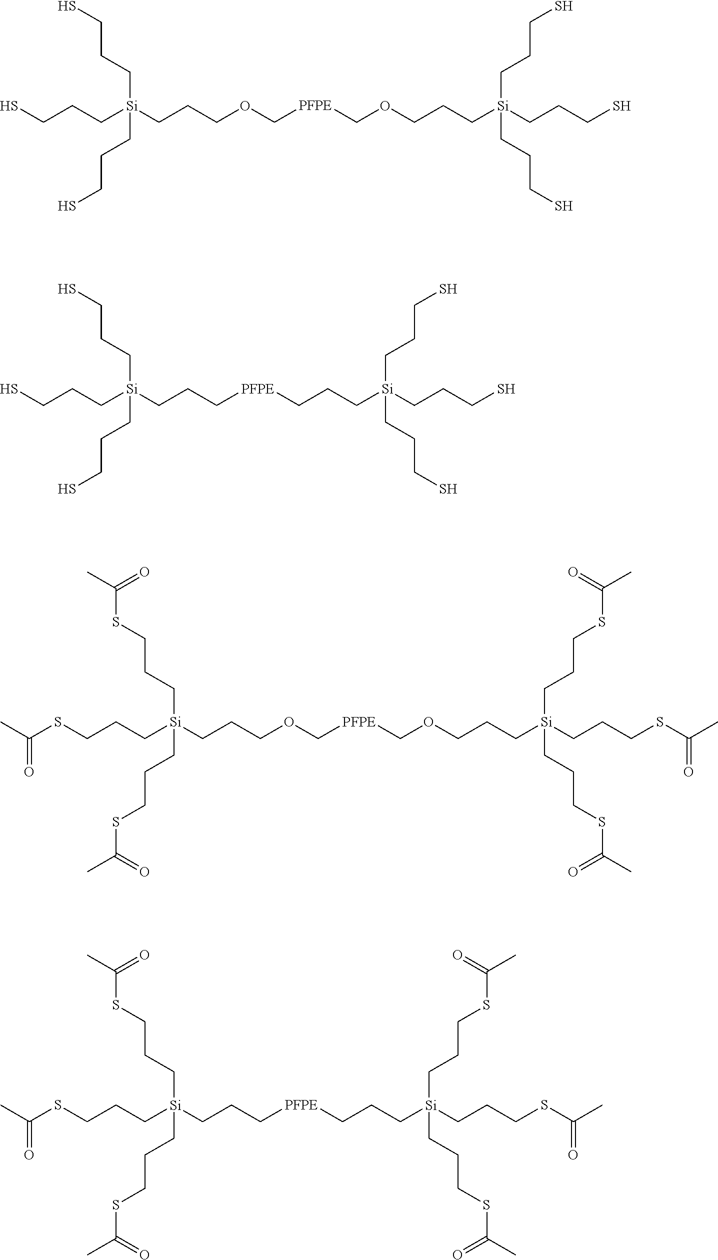

### (Method for Producing Compound (1-2))

As one example of the method for producing the compound (1-2), the production method by a thiol-ene reaction of a compound (2a-1) and the above-mentioned compound (1b-1) may be mentioned.

[R²¹]_{g21}[CH₂═CH-L^{a21}-]_{g22}Z²¹—Y²¹—(OX)ₘ—O—Y²²—Z²²[-L^{a22}-CH═CH₂]_{g23}[R²⁴]_{g24} (2a-1)

In the formula (2a-1), the definitions of R²¹, R²⁴, Z²¹, Z²², Y²¹, Y²², X, m, g21, g22, g23 and g24 are as described above, and L^{a21} and L^{a22} are each independently a single bond or a divalent linking group. As specific examples of the divalent linking group in L^{a21} and L^{a22}, the divalent linking groups in L²¹ and L²² as described above may be mentioned.

By the reaction of the compound (2a-1) and the compound (1b-1), it is possible to obtain a compound (1-2) in which L²¹ has a structure derived from CH₂=CH-L^{a21} of the compound (2a-1), L²² has a structure derived from L^{a22}-CH═CH₂ of the compound (2a-1), and R²² and R²³ are R¹¹¹.

As another method for producing a compound (1-2), a production method by a thiol-ene reaction of the above-described compound (2a-1) and the above-described compound (1b-2), may be mentioned.

By the reaction of the compound (2a-1) and the compound (1b-2), it is possible to obtain a compound (1-2) in which L²¹ has a structure derived from CH₂=CH-L^{a21} of the compound (2a-1) and L^{a2}-SH of the compound (1b-2), L²² has a structure derived from L^{a22}-CH═CH₂ of the compound (2a-1) and L^{ae}-SH of the compound (1b-2), and R²² and R²³ are hydrogen atoms.

### [Composition]

The composition of the present invention comprises at least one of the above-described compound (1-1) and compound (1-2), and a liquid medium. The composition of the present invention is preferably used as a composition for forming a water and oil repellent layer excellent in abrasion resistance on a substrate by a wet coating method.

In the following, the compound (1-1) and compound (1-2) will be collectively referred to also as a “compound (1)”. For example, “containing a compound (1)” means containing at least one of the compound (1-1) and compound (1-2).

Further, fluorinated ether compounds other than the compound (1) will be hereinafter referred to also as “other fluorinated ether compounds”.

Furthermore, the compound (1) and other fluorinated ether compounds will be collectively referred to also as a “fluorinated ether compound”.

The composition of the present invention may contain other fluorinated ether compounds.

As other fluorinated ether compounds, a compound in which g11 in the above formula (1-1) is 1, as well as a compound which satisfies at least one of such conditions that in the formula (1-2), g22 is 1, g23 is 1, Y²¹ contains at least 2 ester bonds, and Y²² contains at least 2 ester compounds, may be mentioned.

As other fluorinated ether compounds, at least 2 types may be used in combination.

In a case where the composition of the present invention contains a compound (1-1) as the compound (1), the content of the compound (1-1) is preferably at least 10 mass %, more preferably from 10 to 80 mass %, particularly preferably from 10 to 50 mass %, to the total mass of the fluorinated ether compound. In a case where the composition contains a fluorinated ether compound other than the compound (1-1), the content of the fluorinated ether compound other than the compound (1-1) is preferably from 40 to 60 mass %, particularly preferably from 45 to 55 mass %.

In a case where the composition of the present invention contains a compound (1-2) as the compound (1), the content of the compound (1-2) is preferably at least 50 mass %, particularly preferably at least 80 mass %, to the total mass of the fluorinated ether compound. Further, in a case where the composition contains a fluorinated ether compound other than the compound (1-2), the content of the fluorinated ether compound other than the compound (1-2) is preferably from 40 to 60 mass %, particularly preferably from 45 to 55 mass %, to the total mass of the fluorinated ether compound.

The composition of the present invention contains a liquid medium. As specific examples of the liquid medium, water and an organic solvent may be mentioned.

As the liquid medium, an organic solvent is preferred, and, from the viewpoint of superior coating properties, an organic solvent with a boiling point of from 35 to 250° C. is more preferred. Here, the boiling point means the standard boiling point.

As specific examples of the organic solvent, a fluorinated organic solvent and a non-fluorinated organic solvent may be mentioned, and from the viewpoint of superior solubility, a fluorinated organic solvent is preferred. As the organic solvent, at least 2 types may be used in combination.

As specific examples of the fluorinated organic solvent, a fluorinated alkane, a fluorinated aromatic compound, a fluoroalkyl ether, a fluorinated alkylamine and a fluoroalcohol may be mentioned.

As the fluorinated alkane, a C4-8 compound is preferred, and, for example, C₆F₁₃H (AC-2000: product name, manufactured by AGC Inc.), C₆F₁₃C₂H₅ (AC-6000: product name, manufactured by AGC Inc.), and C₂F₅CHFCHFCF₃ (Vertrel: product name, manufactured by DuPont) may be mentioned.

As specific examples of the fluorinated aromatic compound, hexafluorobenzene, trifluoromethylbenzene, perfluorotoluene, 1,3-bis(trifluoromethyl)benzene, and 1,4-bis(trifluoromethyl)benzene, may be mentioned.

As the fluoroalkyl ether, a C4-12 compound is preferred, and, for example, CF₃CH₂OCF₂CF₂H (AE-3000: product name, manufactured by AGC Inc.), C₄F₉OCH₃ (Novec-7100: product name, manufactured by 3M), C₄F₉OC₂H₅ (Novec-7200: product name, manufactured by 3M), and C₂F₅CF(OCH₃)C₃F₇ (Novec-7300: product name, manufactured by 3M) may be mentioned.

As specific examples of the fluorinated alkylamine, perfluorotripropylamine and perfluorotributylamine may be mentioned.

As specific examples of the fluoroalcohol, 2,2,3,3-tetrafluoropropanol, 2,2,2-trifluoroethanol, and hexafluoroisopropanol may be mentioned.

As the non-fluorinated organic solvent, a compound consisting only of hydrogen atoms and carbon atoms, and a compound consisting only of hydrogen atoms, carbon atoms, and oxygen atoms, are preferred, and, specifically a hydrocarbon type organic solvent, a ketone type organic solvent, an ether type organic solvent, an ester type organic solvent, and an alcohol type organic solvent, may be mentioned.

As specific examples of the hydrocarbon type organic solvent, hexane, heptane, and cyclohexane may be mentioned.

As specific examples of the ketone type organic solvent, acetone, methyl ethyl ketone, and methyl isobutyl ketone may be mentioned.

As specific examples of the ether type organic solvent, diethyl ether, tetrahydrofuran, and tetraethylene glycol dimethyl ether may be mentioned.

As specific examples of the ester type organic solvent, ethyl acetate and butyl acetate may be mentioned.

As specific examples of the alcohol type organic solvent, isopropyl alcohol, ethanol, and n-butanol may be mentioned.

As the content of the liquid medium in the composition of the present invention, to the total mass of the composition, from 70 to 99.9 mass % is preferred, and from 80 to 99.9 mass % is particularly preferred.

The composition of the present invention may contain components other than those mentioned above to such an extent that they do not impair the effects of the present invention.

As other components, by-products formed in the production process of the compound (1) and other fluorinated ether compounds, and unavoidable compounds in the production, such as unreacted raw materials, may be mentioned.

When the composition contains other components, the content of such other components is preferably at most 10 mass %, more preferably at most 5 mass %, particularly preferably at most 1 mass %, to the content of the compound (1) in the composition of the present invention.

[Water and Oil Repellent Agent and Method for Producing Substrate Provided with Water and Oil Repellent Layer]

The compound (1) of the present invention and the composition of the present invention are useful as a water and oil repellent agent for forming a water and oil repellent layer on the surface of a substrate. In particular, they are useful as a water and oil repellent agent for forming a water and oil repellent layer on a metal surface of a substrate having the metal surface or on a resin surface of a substrate having the resin surface.

In the case of a water and oil repellent agent containing the compound (1), it is possible to form a water and oil repellent layer on the surface of a substrate by treating the surface of the substrate by a dry coating method using the water and oil repellent agent. The present invention is also a method of producing a substrate provided with a water and oil repellent layer, characterized by treating the surface of the substrate by a dry coating method using the water and oil repellent agent to form a water and oil repellent layer on the surface of the substrate.

In the case of a water and oil repellent agent consisting of the composition of the present invention, it is possible to form a water and oil repellent layer on the surface of a substrate by applying said composition to the surface of the substrate by a wet coating method using the composition of the present invention, followed by drying. The present invention is also a method for producing a substrate provided with a water and oil repellent layer, characterized by applying said composition to the surface of the substrate by a wet coating method using the composition of the present invention, followed by drying to form a water and oil repellent layer on the surface of the substrate.

In the above method for producing a substrate provided with a water and oil repellent layer, the formation of the water and oil repellent layer on the surface of the substrate may be conducted on the substrate that constitutes the article, or on the substrate as a member before constituting the article. In the former case, by the above production method, a later-described article provided with a water and oil repellent layer will be formed from the article and the water and oil repellent agent.

The water and oil repellent agent containing the compound (1) to be used in the dry coating method may have other components that may be deposited on the surface of the substrate together with the compound (1) in the dry coating method. Such other components may be fluorinated ether compounds other than the compound (1), which are mentioned as may be contained together with the compound (1) in the composition of the present invention, except for the liquid medium in the composition of the present invention. When the water and oil repellent agent contains fluorinated ether compounds other than the compound (1), the relative proportions of the compound (1) and other fluorinated ether compounds in the water and oil repellent agent is preferably the same as the proportions in the composition of the present invention. The same applies also when the water and oil repellent agent further contains other components other than the fluorinated ether compounds other than the compound (1).

As specific examples of the dry coating method, a vacuum vapor deposition method, a CVD method and a sputtering method may be mentioned. Among them, the vacuum vapor deposition method is suitable from the viewpoint of suppressing the decomposition of the compound (1) and simplicity of the device.

As specific examples of the wet coating method in the wet coating method using the composition of the present invention, a spin coating method, a wipe coating method, a spray coating method, a squeegee coating method, a dip coating method, a die coating method, an ink jetting method, a flow coating method, a roll coating method, a cast method, a Langmuir Blodgett method and a gravure coating method may be mentioned.

As the substrate on which the water and oil repellent layer is formed, a substrate of which the surface on which the water and oil repellent layer is to be formed is a metal or resin surface is preferred, and a substrate of which the surface is a metal surface is particularly preferred. The substrate of which the surface on which the water and oil repellent layer is to be formed is a metal surface, may be a substrate made of a metal material or may be a composite substrate having a metal layer on the surface of the main body made of a non-metal material such as a resin, glass or ceramics. Similarly, in the case of a substrate made of a metal material, it may be a composite metal substrate having a metal layer made of a metal different from the main body on the surface of the metal main body.

As the metal layer on the surface of the substrate, preferred is a metal layer formed by forming a thin metal layer on the surface of the substrate main body by plating, vapor deposition, etc., or by laminating a metal film on the surface of the substrate main body. The metal layer may have a multilayer structure, but the surface on which the water and oil repellent layer is to be formed means the outermost layer in contact with the water and oil repellent layer. Further, between the substrate main body and the metal layer as the outermost layer, there may be an intermediate layer made of a material different from both, which is provided for the purpose of improving the bonding strength of the two, etc.

The metal surface at the substrate surface may be the entire surface or a portion of the substrate surface. For example, in the case of a sheet substrate, the entire surface of one side of the sheet may be a metal surface, or a portion of one side may be a metal surface. In a case where the substrate main body is made of a non-metal material, the water and oil repellent layer is usually formed on the metal surface where the metal layer is present.

In a case where the surface on which the water and oil repellent layer is to be formed in the substrate, is a metal surface, as the material to constitute the metal surface, a metal material containing at least one type of metal selected from the group consisting of gold, silver and copper is preferred. Specifically, it may be a single metal of these metals, an alloy of at least 2 types of these metals, an alloy of at least one of these metals and a metal other than these metals, etc. From such a viewpoint that the abrasion resistance of the water and oil repellent layer will be superior, as the metal material for the metal surface, a metal material containing gold, is preferred, and from such a viewpoint that the designability will be high, it is more preferred that the metal material is a single metal or a gold alloy.

In a case where the material of the substrate main body or the material constituting the substrate surface other than the metal surface is a non-metal material, as the non-metal material, a resin, glass, sapphire, ceramic, stone and a composite of these materials may be mentioned. Glass may be chemically strengthened.

As a substrate of which the surface on which the water and oil repellent layer is to be formed is a resin surface, it may be a substrate made of the resin material, or a composite substrate having a resin layer on the surface of the main body made of a non-resin material such as glass, ceramics or metal. Similarly, in the case of a substrate made of a resin material, it may be a substrate having a resin layer made of a resin different from the main body on the surface of the main body made of a resin material.

As a substrate, particularly preferred is a substrate having a surface that comes into contact with human skin, such as an article that may be held by human fingers (e.g. a stylus) or an article that may be used in contact with human fingers during operation (e.g. a touch panel). In such a case, a water and oil repellent layer is formed on the surface of the substrate that is at least in contact with human skin. The surface of the substrate on which the water and oil repellent layer is to be formed is preferably a metal surface, as described above.

Specifically, a substrate for a touch panel and a display substrate are preferred, and a substrate for a touch panel is particularly preferred. The substrate for a touch panel preferably has transparency for visible light. The term “has transparency for visible light” means that the transmittance of perpendicularly incident visible light in accordance with JIS R3106: 1998 (ISO 9050: 1990) is at least 25%. The material for the substrate for a touch panel is preferably glass or a transparent resin.

Further, as the substrate, also preferred is a substrate, of which the main body is made of glass or a resin film, that constitutes an exterior portion (excluding a display portion) in devices such as cell phones (e.g. smartphones), mobile information devices, game consoles, and remote controls.

The thickness of the water and oil repellent layer formed on the surface of the substrate is preferably from 1 to 100 nm, particularly preferably from 1 to 50 nm. When the thickness of the water and oil repellent layer is at least the lower limit value, the effects by the water and oil repellent layer can be sufficiently obtained. When the thickness of the water and oil repellent layer is at most the above upper limit value, the utilization efficiency will be high.

In the present invention, the thickness obtained by an X-ray diffractometer for thin film analysis is defined as the thickness of the water and oil repellent layer. The thickness of the water and oil repellent layer is determined by obtaining an interference pattern of reflective X rays by an X-ray reflectivity method using an X-ray diffractometer for thin film analysis (manufactured by RIGAKU, ATX-G) and calculating from the oscillation period of the interference pattern.

The water and oil repellent layer may be formed directly on the surface of the substrate, or it may be formed on the substrate via another film formed on the surface of the substrate. As a specific example of another film mentioned above, an underlayer to be formed on the surface of the substrate by subjecting the substrate to underlayer treatment with a compound disclosed in paragraphs 0089 to 0095 of WO2011/016458, SiO₂, etc., may be mentioned.

[Article Provided with a Water and Oil Repellent Layer]

The article provided with a water and oil repellent layer of the present invention comprises a substrate having a metal surface, and a water and oil repellent layer formed from the compound (1) or the composition of the present invention on the metal surface of the substrate.

The article provided with a water and oil repellent layer can be obtained by forming a water and oil repellent layer on the metal surface at the surface of an article as described above (i.e. on the metal surface of the substrate constituting the article), or by constituting the article by using the substrate provided with a water and oil repellent layer as a component before constituting the article.

As the article, as mentioned above, a touch panel, a display, a cell phone (e.g. a smart phone), a mobile information device, a game console, a remote control, a stylus, etc., may be mentioned.

### EXAMPLES

In the following, the present invention will be described in detail with reference to Examples. Ex. 1, Ex. 2 and Ex. 4 to 7 are Examples of the present invention, and Ex. 3 is a Comparative Example. However, the present invention is not limited to these Examples. The blend amounts of the respective components in Table given later are based on mass.

### [Evaluation Methods]

### (Water Contact Angle)

The contact angle of about 2 μL of distilled water placed on the surface of the water and oil repellent layer was measured at 20° C. by using a contact angle measurement device (DM-701 manufactured by Kyowa Interface Science Co., Ltd.). Measurements were conducted at three different locations on the surface of the water and oil repellent layer, and the average value was calculated and used as the initial contact angle. The 2θ method was used to calculate the contact angle.

### (Abrasion Resistance)

The surface of the water and oil repellent layer was wiped 20 times with a Bencot having a fluorinated organic solvent (Asahiklin AE3000, manufactured by AGC Inc.) impregnated, and then wiped 20 times with a Bencot having ethanol impregnated. After that, the water contact angle of the water and oil repellent layer (water contact angle after abrasion test) was measured by the method as described above.

The smaller the decrease in the water contact angle after the abrasion test, the better the abrasion resistance of the water and oil repellent layer.

### Synthesis Example 1 (Synthesis of Compound (1-1A))

In accordance with the method disclosed in Ex. 11-2 of WO2017/038830, the following compound (1-1X) was obtained.

CF₃—(OCF₂CF₂OCF₂CF₂CF₂CF₂)ₙ(OCF₂CF₂)—OCF₂CF₂CF₂—C(O)NH—CH₂—C(CH₂CH═CH₂)₃

Average value of the number of units n: 13, Mn of compound (1-1X): 4,800.

Into a 50 mL round bottom flask, 5.0 g of the compound (1-1X), 5.0 g of 1,3-bis(trifluoromethyl)benzene were put, and while adding 0.05 g of azobisisobutyronitrile and 1.0 g of (3-mercaptopropyl) trimethoxysilane, the temperature was raised to 65° C. After 14 hours, the organic layer was distilled off under reduced pressure. The solution was dissolved in AC-6000 and filtered to obtain a filtrate, and the solvent was distilled to obtain 4.7 g (yield: 83%) of compound (1-1A).

CF₃—(OCF₂CF₂OCF₂CF₂CF₂CF₂)ₙ(OCF₂CF₂)—OCF₂CF₂CF₂—C(O)NH—CH₂—C[CH₂CH₂CH₂—S—CH₂CH₂CH₂—Si(OCH₃)₃]₃ (1-1A)

Average value of the number of units n: 13, Mn of compound (1-1A): 5,400.

### Synthesis Example 2 (Synthesis of Compound (1-1B))

Into a 50 mL round bottom flask, 5 g of the above compound (1-1X) and 5.0 g of 1,3-bis(trifluoromethyl)benzene were put, and while adding 0.05 g of azobisisobutyronitrile and 1.5 g of 1,2-ethanedithiol and stirring, the temperature was raised to 65° C. After 14 hours, the organic layer was distilled off under reduced pressure. The solution was dissolved in AC-6000 and filtered to obtain a filtrate, and the solvent was distilled to obtain 4.0 g (yield: 75%) of compound (1-1B).

CF₃—(OCF₂CF₂OCF₂CF₂CF₂CF₂)ₙ(OCF₂CF₂)—OCF₂CF₂CF₂—C(O)NH—CH₂—C(CH₂CH₂CH₂—S—CH₂CH₂SH)₃ (1-1B)

Average value of the number of units x3: 13, Mn of compound (1-1B): 5,100.

### Synthesis Example 3 (Synthesis of Compound (X1))

In accordance with the method disclosed in Ex. 11 of WO2017/038830, compound (X1) was obtained.

CF₃—(OCF₂CF₂OCF₂CF₂CF₂CF₂)ₙ(OCF₂CF₂)—OCF₂CF₂CF₂—C(O)NH—CH₂—C[CH₂CH₂CH₂—Si(OCH₃)₃]₃ (X1)

Average value of the number of units n: 13, Mn of compound (X1): 5,400.

### Synthesis Example 4 (Synthesis of Compound (1-1C))

To 1.0 g of compound (1-1X), 1.1 g of AC2000 (manufactured by AGC Inc.), 0.03 g of azobisisobutyronitrile and 0.11 g of thioacetic acid were added, followed by stirring at 80° C. for 14 hours. After washing with 10 mL of methanol, further 1 g of each of methanol, a 1M hydrochloric acid solution and AC2000 were added, and an extraction operation was carried out with AC2000. Subsequently, purification was carried out by column chromatography to obtain 0.5 g of compound (1-1C).

CF₃—(OCF₂CF₂OCF₂CF₂CF₂CF₂)ₙ—OCF₂CF₂—OCF₂CF₂CF₂—C(O)NH—CH₂—C(CH₂CH₂CH₂—S—CO—CH₃)₃ (1-1C)

Average value of the number of units n: 13, Mn of compound (1-1C): 5,000.

### Synthesis Example 5 (Synthesis of Compound (1-1 D))

To 0.5 g of compound (1-1C), 5 g of AC2000 and 5 g of methanol were added, and 2.0 g of tributylphosphine was added. 0.75 g of potassium carbonate was added, followed by stirring at room temperature for 6 hours. Then, a 1M hydrochloric acid solution was added until the solution became acidic, whereupon it was extracted with AC2000, and washed with dichloromethane. The obtained mixture was purified by column chromatography to obtain 0.16 g of compound (1-1D).

CF₃—(OCF₂CF₂OCF₂CF₂CF₂CF₂)ₙ—OCF₂CF₂—OCF₂CF₂CF₂—C(O)NH—CH₂—C(CH₂CH₂CH₂—SH)₃ (1-1D)

Average value of the number of units n: 13, Mn of compound (1-1 D): 4,800.

### [Synthesis Example 6 (Synthesis of Compound (1-2A))

The following compound (X2) was synthesized in accordance with the method disclosed in Ex. 1 of WO2020/162371.

(CH═CHCH₂)₃—C—CH₂—HN(O)C—CF₂CF₂CF₂O—CF₂CF₂O(CF₂CF₂CF₂CF₂OCF₂CF₂O)ₘ—XF—(OCF₂CF₂OCF₂CF₂CF₂CF₂)ₙ—OCF₂CF₂—OCF₂CF₂CF₂—C(O)NH—CH₂—C(CH₂CH═CH₂)₃

XF in the above formula represents the following structure. * represents the bonding position.

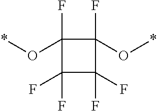 [SMILES: *OC1(F)C(F)(F)C(F)(F)C1(F)O*]

Average value of the number of units m+n: 10.

To 1.0 g of compound (X2), 1.1 g of AC2000 (manufactured by AGC Inc.), 0.01 g of azobisisobutyronitrile and 0.21 g of thioacetic acid were added, followed by stirring at 80° C. for 13 hours. After washing with 10 mL of dichloromethane, purification was carried out by column chromatography, to obtain 0.7 g of compound (1-2A).

(CH₃—C(O)S—CH₂CH₂CH₂)₃—C—CH₂—HN(O)C—CF₂CF₂CF₂O—CF₂CF₂O(CF₂CF₂CF₂CF₂OCF₂CF₂O)ₘ—XF—(OCF₂CF₂OCF₂CF₂CF₂CF₂)ₙ—OCF₂CF₂—OCF₂CF₂CF₂—C(O)NH—CH₂—C(CH₂CH₂CH₂—S—C(O)CH₃)₃ (1-2A)

Average value of the number of units m+n: 10, Mn of compound (1-2A): 4,200.

### Synthesis Example 7 (Synthesis of Compound (1-26))

To 1.8 g of compound (1-2A), 5 g of AC2000, 4 g of methanol and 2 g of tributylphosphine were added. Then, 0.8 g of potassium carbonate was added, followed by stirring at room temperature for 1.5 hours. After washing with 10 mL of dichloromethane, purification was carried out by column chromatography, to obtain 0.5 g of compound (1-2B).

(HS—CH₂CH₂CH₂)₃—C—CH₂—HN(O)C—CF₂CF₂CF₂O—CF₂CF₂O(CF₂CF₂CF₂CF₂OCF₂CF₂O)ₘ—XF—(OCF₂CF₂OCF₂CF₂CF₂CF₂)ₙ—OCF₂CF₂—OCF₂CF₂CF₂—C(O)NH—CH₂—C(CH₂CH₂CH₂—SH)₃ (1-2B)

Average value of the number of units m+n: 10, Mn of compound (1-213): 4,200.

### Ex. 1

On a molybdenum boat in a vacuum vapor deposition apparatus (VTR-350M manufactured by ULVAC), 0.16 g of compound (1-1A) was placed as a vapor deposition source.

The following substrate 1 was placed in the vacuum vapor deposition apparatus, and the inside of the vacuum vapor deposition apparatus was evacuated until the pressure became to be at most 5×10⁻³ Pa. The above boat was heated until it reached about 1,000° C., and compound (1-1A) was vacuum vapor deposited on the surface of the substrate 1, and when the thickness of the compound (1-1A) became to be about 15 nm, the film deposition was completed. The compound (1-1A) was deposited, and an evaluation sample (article provided with a water and oil repellent layer) was obtained in which the substrate and the water and oil repellent layer were laminated in this order. The evaluation results of the evaluation sample are shown in Table 1.

Substrate 1: A substrate (diameter: 25 mm, thickness: 5 mm) having the surface of glass coated with chromium (film thickness: 50 to 60 nm) and gold (film thickness: 200 nm) in this order, and having gold equipped on the top surface.

### Ex. 2

The evaluation sample of Ex. 2 (article provided with a water and oil repellent layer) was obtained in the same manner as in Ex. 1, except that compound (1-1B) was used instead of compound (1-1A). The evaluation results of the evaluation sample are shown in Table 1.

### Ex. 3

In a copper hearth in a vacuum vapor deposition apparatus (VTR-350M manufactured by ULVAC), 30 g of silicon oxide was placed as the vapor deposition source, and in a molybdenum boat, 0.16 g of compound (X1) was placed as the vapor deposition source.

The above substrate 1 was placed in the vacuum vapor deposition apparatus, and the inside of the vacuum vapor deposition apparatus was evacuated until the pressure became to be at most 5×10⁻³ Pa. The above hearth was heated until it reached about 2,000° C., and silicon oxide was vacuum vapor deposited on the surface of the substrate to produce a substrate provided with a silicon oxide layer having a thickness of about 20 nm. Then, the above boat was heated until it reached about 1,000° C., and the compound (X1) in the composition was vacuum vapor deposited on the surface of the silicon oxide layer. When the thickness of the film on the silicon oxide layer became to be about 15 nm, the film deposition was completed. The article on which the compound (X1) was deposited was heat-treated at 140° C. for 30 minutes, to obtain an evaluation sample (article provided with a water and oil repellent layer) in which the substrate, silicon oxide layer, and water and oil repellent layer were laminated in this order. The evaluation results of the evaluation sample are shown in Table 1.

### Ex. 4 to 7

Evaluation samples (articles provided with water and oil repellent layers) in Ex. 4 to 7 were obtained in the same manner as in Ex. 1, except that the compounds in Table 1 were used instead of compound (1-1A). The evaluation results of the evaluation samples are shown in Table 1.

TABLE 1

| | Type of fluorinated | Water contact angle (degrees) | |
|---|---|---|---|
| | ether compound | Initial | After abrasion test |
| Ex. 1 | 1-1A | 114 | 110 |
| Ex. 2 | 1-1B | 110 | 105 |
| Ex. 3 | X1 | 113 | 84 |
| Ex. 4 | 1-1C | 117 | 112 |
| Ex. 5 | 1-1D | 117 | 112 |
| Ex. 6 | 1-2A | 102 | 93 |
| Ex. 7 | 1-2B | 117 | 113 |

As shown in Table 1, it has been confirmed that when compound (1-1) and compound (1-2) are used, it is possible to form a water and oil repellent layer excellent in abrasion resistance.

The article provided with a water and oil repellent layer of the present invention can be used in various applications where it is desired to impart water and oil repellency. For example, it can be used for display input devices such as touch panels, transparent glass or transparent plastic members, lenses for glasses, kitchen stain-proof members, water and moisture-proof members and stain-proof members for electronic devices, heat exchangers, batteries, etc., stain-proof members for toiletries, members that need liquid repellency while conducting, water repellent, waterproof and water-sliding members for heat exchangers, and low-abrasion surface members for vibrating sieves or cylinder interiors, etc. As more specific examples of use, front protection plates of displays, anti-reflection plates, polarizing plates, anti-glare plates, or ones having their surfaces treated with anti-reflection films, various devices having display input devices that allow operation with a human finger or palm on the screen of touch panel sheets or touch panel displays of devices such as cell phones (e.g. smart phones), mobile information devices, game consoles, and remote controls (e.g. glass or film used for displays, etc., as well as glass or film used for exterior parts other than displays), may be mentioned. In addition to the above, decorative building materials for water-related areas, such as toilets, baths, lavatories, kitchens, etc., waterproof members for wiring boards, water-repellent, waterproof and water-sliding members for heat exchangers, water-repellent members for solar cells, waterproof and water-repellent members for printed wiring boards, waterproof and water-repellent members for electronic equipment housings and electronic components, members for improving the insulation of power transmission lines, waterproof and water-repellent members for various filters, waterproof members for radio wave absorbers and sound absorbers, stain-proof members for baths, kitchen equipment, toiletries, etc., low-abrasion surface members for vibrating sieves and cylinder interiors, members for machinery, vacuum equipment, bearing members, members for transportation equipment such as automobiles, etc., surface protection members for tools, etc., may be mentioned.

This application is a continuation of PCT Application No. PCT/JP2020/045524, filed on Dec. 7, 2020, which is based upon and claims the benefit of priority from Japanese Patent Application No. 2019-225334 filed on Dec. 13, 2019 and Japanese Patent Application No. 2020-146621 filed on Sep. 1, 2020. The contents of those applications are incorporated herein by reference in their entireties.

What is claimed is:

1. A fluorinated ether compound characterized by being represented by the formula (1-1):
[R^{f}—(OX)ₘ—O—]ⱼ₁Y¹—Z¹[-L¹-S—R¹¹]_{g11}[R¹²]_{g12} (1-1)
in the formula (1-1),
R^{f} is a perfluoroalkyl group,
X is a fluoroalkylene group having at least one fluorine atom,
m is an integer of at least 2,
Y¹ is a single bond or a (j1+1) valent linking group,
Z¹ is a (g11+g12+1) valent linking group,
L¹ is a single bond or a divalent linking group,
R¹¹ is a hydrogen atom or a monovalent substituent,
R¹² is a monovalent substituent,
j1 is an integer of at least 1,
g11 is an integer of at least 2, and
g12 is an integer of at least 0.

2. The fluorinated ether compound according to claim 1, wherein g11 in the formula (1-1) is an integer of at least 3.

3. A fluorinated ether compound characterized by being represented by the formula (1-2):
[R²¹]_{g21}[R²²—S-L²¹-]_{g22}Z²¹—Y²¹—(OX)ₘ—O—Y²²—Z²²[-L²²-S—R²³]_{g23}[R²⁴]_{g24} (1-2)
in the formula (1-2),
R²¹ and R²⁴ are each independently a monovalent substituent,
R²² and R²³ are each independently a hydrogen atom or a monovalent substituent,
L²¹ and L²² are each independently a single bond or a divalent linking group,
Z²¹ is a (g21+g22+1) valent linking group,
Z²² is a (g23+g24+1) valent linking group,
Y²¹ and Y²² are each independently a single bond or a divalent linking group,
X is a fluoroalkylene group having at least one fluorine atom,
m is an integer of at least 2,
g21 and g24 are each independently an integer of at least 0, and
g22 and g23 are each independently an integer of at least 2,
provided that neither Y²¹ nor Y²² contains at least two ester bonds.

4. The fluorinated ether compound according to claim 3, wherein g22 and g23 in the above formula (1-2) are each independently an integer of at least 3.

5. A composition characterized by containing a fluorinated ether compound as claimed in claim 1 and a liquid medium.

6. A water and oil repellent agent comprising a fluorinated ether compound as claimed in claim 1.

7. The water and oil repellent agent according to claim 6, for forming a water and oil repellent layer on a metal surface of a substrate having the metal surface.

8. The water and oil repellent agent according to claim 7, wherein said metal surface is a metal surface containing at least one metal selected from the group consisting of gold, silver and copper.

9. A method for producing a substrate with a water and oil repellent layer, characterized by treating the surface of the substrate by a dry coating method using a fluorinated ether compound as defined in claim 1, to form a water and oil repellent layer on the surface of the substrate.

10. A method for producing a substrate with a water and oil repellent layer, characterized by applying said composition to the surface of the substrate by a wet coating method using the composition as claimed in claim 5, followed by drying to form a water and oil repellent layer on the surface of the substrate.

11. An article provided with a water and oil repellent layer, characterized by comprising a substrate having a metal surface, and a water and oil repellent layer formed on the metal surface of the substrate, from a fluorinated ether compound as claimed in claim 1.

12. The article provided with a water and oil repellent layer according to claim 11, wherein the substrate having a metal surface is a substrate having a surface comprising at least one metal selected from the group consisting of gold, silver and copper.
